(19) United States
(12) Patent Application Publication
(10) Pub. No.: US 2025/0310367 A1
(43) Pub. Date: Oct. 2, 2025

(54) Continuously Assessing External Risk for Internet-Facing Assets

(71) Applicant: Abricto Security LLC, Peachtree Corners, GA (US)

(72) Inventors: Cornelis Johannes du Preez, Cumming, GA (US); Richard Brent Brackin, Sandy Springs, GA (US); Anthony Myron Clarence Ralston, Charlotte, NC (US)

(73) Assignee: Abricto Security LLC, Peachtree Corners, GA (US)

(21) Appl. No.: 18/621,714

(22) Filed: Mar. 29, 2024

(51) Int. Cl. H04L 9/40

(52) U.S. Cl. CPC H04L 63/1433; H04L 63/1425

(57) ABSTRACT

The concepts and technologies disclosed herein are directed to continuous external risk assessment for Internet-facing assets. In one or more implementations, a system can execute a web crawl using a plurality of seed uniform resource locators. The system can execute a domain name service subdomain scan and a subdomain scan. The system can obtain asset data associated with one or more client assets. The system can determine, based upon the asset data and results of the web crawl, the domain name service subdomain scan, and the subdomain scan, whether each domain of a plurality of domains is known.

### BACKGROUND

Conventional network vulnerability scanning is a critical cybersecurity practice designed to identify, assess, and prioritize vulnerabilities within network systems and connected devices. This process involves the use of automated scanning tools that systematically scan network segments, servers, endpoints, and other network devices for known vulnerabilities, such as unpatched software, misconfigurations, weak passwords, and open ports. These scanning tools typically reference a database of known vulnerabilities, such as the Common Vulnerabilities and Exposures (CVE) list, to detect potential security weaknesses. Once vulnerabilities are identified, the scanner generates reports detailing the findings, including the severity of each vulnerability and recommendations for mitigation or remediation.

### SUMMARY

Concepts and technologies are described herein for continuously assessing external risks for Internet-facing assets. In some aspects the concepts and technologies described herein relate to a method performed by an enumeration server system. In particular, the method can include executing a web crawl using a plurality of seed uniform resource locators, executing a domain name service subdomain scan, executing a subdomain scan, obtaining asset data associated with one or more client assets, and determining, based upon the asset data and results of the web crawl, the domain name service subdomain scan, and the subdomain scan, whether each domain of a plurality of domains is known.

In some aspects, the concepts and technologies described herein relate to a method, wherein executing the web crawl includes initializing a web crawler service, obtaining the plurality of seed uniform resource locators as initial points of entry for the web crawl, performing the web crawl via the web crawler service using the plurality of seed uniform resource locators as the initial points of entry for the web crawl, and outputting results of the web crawl.

In some aspects, the concepts and technologies described herein relate to a method, further including, responsive to determining a specific domain of the plurality of domains is unknown, determining whether the specific domain of the plurality of domains is in-scope.

In some aspects, the concepts and technologies described herein relate to a method, further including, responsive to determining that the specific domain of the plurality of domains is out-of-scope, dropping the specific domain from further consideration.

In some aspects, the concepts and technologies described herein relate to a method, further including, responsive to determining that the specific domain of the plurality of domains is in-scope, inserting the specific domain into a host table for further consideration.

In some aspects, the concepts and technologies described herein relate to a method, further including classifying the specific domain based on an assessed significance of the one or more client assets.

In some aspects, the concepts and technologies described herein relate to a method, further including determining whether the specific domain is hosted by a third-party.

In some aspects, the concepts and technologies described herein relate to a method, further including, responsive to determining that the specific domain is hosted by the third-party, determining whether the specific domain is approved to be scanned; and responsive to determining that the specific domain is hosted by the third-party and is approved to be scanned, determining whether the specific domain is associated with a web application.

In some aspects, the concepts and technologies described herein relate to a method, further including, responsive to determining that the specific domain is associated with the web application, adding a new host associated with the specific domain to a port scan and to a dynamic application security testing scan, and instructing a scanner cluster server system to perform the port scan and the dynamic application security testing scan on the new host.

In some aspects, the concepts and technologies described herein relate to a method, further including, responsive to determining that the specific domain is associated with the web application, adding a new host associated with the specific domain to a port scan, and instructing a scanner cluster server system to perform the port scan on the new host.

In some aspects, the concepts and technologies described herein relate to a system including a processor, and a memory including computer-executable instructions that, when executed by the processor, cause the processor to perform operations. The operations can include executing a web crawl using a plurality of seed uniform resource locators, executing a domain name service subdomain scan; executing a subdomain scan, obtaining asset data associated with one or more client assets, and determining, based upon the asset data and results of the web crawl, the domain name service subdomain scan, and the subdomain scan, whether each domain of a plurality of domains is known.

In some aspects, the concepts and technologies described herein relate to a system, wherein executing the web crawl includes initializing a web crawler service, obtaining the plurality of seed uniform resource locators as initial points of entry for the web crawl, performing the web crawl via the web crawler service using the plurality of seed uniform resource locators as the initial points of entry for the web crawl, and outputting results of the web crawl.

In some aspects, the concepts and technologies described herein relate to a system, wherein the operations further include, responsive to determining a specific domain of the plurality of domains is unknown, determining whether the specific domain of the plurality of domains is in-scope.

In some aspects, the concepts and technologies described herein relate to a system, wherein the operations further include, responsive to determining that the specific domain of the plurality of domains is out-of-scope, dropping the specific domain from further consideration, or responsive to determining that the specific domain of the plurality of domains is in-scope, inserting the specific domain into a host table for further consideration.

In some aspects, the concepts and technologies described herein relate to a system, wherein the operations further include classifying the specific domain based on an assessed significance of the one or more client assets.

In some aspects, the concepts and technologies described herein relate to a system, wherein the operations further include determining whether the specific domain is hosted by a third-party.

In some aspects, the concepts and technologies described herein relate to a system, wherein the operations further include, responsive to determining that the specific domain is hosted by the third-party, determining whether the specific domain is approved to be scanned, and responsive to determining that the specific domain is hosted by the third-party and is approved to be scanned, determining whether the specific domain is associated with a web application.

In some aspects, the concepts and technologies described herein relate to a system, wherein the operations further include, responsive to determining that the specific domain is associated with the web application, adding a new host associated with the specific domain to a port scan and to a dynamic application security testing scan, and instructing a scanner cluster server system to perform the port scan and the dynamic application security testing scan on the new host.

In some aspects, the concepts and technologies described herein relate to a system, wherein the operations further include, responsive to determining that the specific domain is associated with the web application, adding a new host associated with the specific domain to a port scan, and instructing a scanner cluster server system to perform the port scan on the new host.

In some aspects, the concepts and technologies described herein relate to a computer-readable storage medium having computer-executable instructions stored thereon that, when executed by a processor, cause the processor to perform operations. The operations can include obtaining asset data associated with one or more client assets; determining, based upon the asset data, results of a web crawl, results of a domain name service subdomain scan, and results of a subdomain scan, whether each domain of a plurality of domains is known, responsive to determining a specific domain of the plurality of domains is unknown, determining whether the specific domain of the plurality of domains is in-scope, responsive to determining that the specific domain of the plurality of domains is in-scope, inserting the specific domain into a host table for further consideration, and classifying the specific domain based on an assessed significance of the one or more client assets.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The detailed description is described with reference to the accompanying figures. Entities represented in the figures are indicative of one or more entities and thus reference is made interchangeably to single or plural forms of the entities in the discussion.

FIG. 1 depicts an operating environment in an example implementation that is operable to employ concepts and technologies described herein.

FIG. 2 depicts a scanner cluster server system in an example implementation that is operable to employ concepts and technologies described herein.

FIG. 3 depicts an enumeration server system in an example implementation that is operable to employ concepts and technologies described herein.

FIG. 4 depicts an environment utility server system in an example implementation that is operable to employ concepts and technologies described herein.

FIGS. 5A-5B depict a flow diagram of a method for asset discovery according to an example implementation.

FIGS. 6A-6C depict a flow diagram of a method for reputational review according to an example implementation.

FIGS. 7A-7B depict a flow diagram of a method for populating a ToScan table for port and dynamic application security testing (DAST) rescanning according to an example implementation.

FIG. 8 depicts a flow diagram of a method for implementing a DAST service according to an example implementation.

FIGS. 9 and 10 depict user interface diagrams showing various aspects of user interfaces for presenting security vulnerability findings according to example implementations.

FIG. 11 depicts an example computer system capable of implementing aspects of the concepts and technologies disclosed herein.

FIG. 12 depicts an example cloud platform capable of implementing aspects of the concepts and technologies disclosed herein.

### DETAILED DESCRIPTION

### Overview

Network vulnerability scanning is a critical cybersecurity practice that involves the systematic examination of a network to identify, classify, and prioritize vulnerabilities in network devices, such as routers, switches, firewalls, and systems connected to the network. This process helps in detecting security weaknesses that could be exploited by attackers to gain unauthorized access, disrupt services, and steal sensitive data.

Conventional network vulnerability scanning is performed using specialized software tools that send various types of network traffic and requests to devices and then analyze the responses to identify known vulnerabilities. These tools can detect issues like unpatched software, open ports, insecure network protocols, misconfigurations, and default passwords. However, these tools fail or are otherwise insufficient to uncover application-layer vulnerabilities.

Application layer vulnerabilities are security weaknesses found in the top layer of the Open Systems Interconnection (OSI) model, which directly interfaces with end-user processes. The application layer is responsible for facilitating application services for file transfers, email, and other network software applications. Vulnerabilities at this layer can be exploited to carry out attacks such as data theft, unauthorized access, and service disruptions.

Application layer vulnerabilities are particularly concerning because they affect the software applications with which users directly interact. Application layer vulnerabilities exist due to various reasons, including poor coding practices, failure to sanitize input/output data, inadequate session management, misconfigurations, and the use of components with known vulnerabilities. By way of example, application layer vulnerabilities include structured query language (SQL) injection, cross-site scripting, cross-site request forgery, insecure direct object references, broken authentication, and security misconfiguration, among others. SQL injection exploits weak input validation to execute malicious SQL queries. Cross-site scripting injects malicious scripts into web pages viewed by other users. Cross-site request forgery tricks users into executing unwanted actions on a web application to which the users are authenticated. Insecure direct object references access or manipulate objects based on user-supplied input. Broken authentication arises when flawed authentication mechanisms are implemented that allow attackers to compromise passwords, keys, or session tokens. Security misconfiguration results from having an insecure default configuration or incomplete setups, which leave applications vulnerable to attack. Mitigating these vulnerabilities requires comprehensive security practices, including secure coding standards, regular code reviews, application security testing (such as dynamic and static analysis), and implementing security features like web application firewalls.

Conventional network vulnerability scanning fails to uncover application-layer vulnerabilities. Bug bounty programs are often implemented to address this limitation of conventional network vulnerability scanning. A bug bounty program is an initiative offered by websites, organizations, and software developers that encourages individuals to report bugs, particularly those related to security vulnerabilities and exploits, in exchange for rewards. These programs are designed to help developers identify and fix bugs before they become known, reducing the risk of widespread abuse. A typical bug bounty program includes a clearly defined scope that specifies the systems, software, or areas eligible for reporting, along with a structured reward system that varies based on the severity and impact of the discovered vulnerability. Participants are provided with detailed reporting guidelines to ensure that submissions contain all necessary information and are communicated through preferred channels. Bug bounty programs are a costly alternative or supplement to conventional network vulnerability scanning. Additionally, bug bounty programs provide a false sense of security as programs become stale and researchers move on to other more lucrative programs.

Accordingly, concepts and technologies for continuously assessing external risk for Internet-facing assets are described. These concepts and technologies address the aforementioned problems with conventional network vulnerability scanning solutions, particularly for organizations with limited resources, but still need greater visibility of their Internet-facing assets and, more broadly, their organization's external risk exposure. These concepts and technologies maximize the efficiency and effectiveness of an organization's risk management program. These concepts and technologies provide a platform that inventories external assets and tracks the constantly changing interrelationships of the organization's digital footprint. Additionally, these concepts and technologies validate defensive controls and uncover Internet-facing, high-risk vulnerabilities that conventional approaches miss.

In one or more examples, systems described herein are configurable to provide comprehensive vulnerability identification and security assessment tailored for applications and network infrastructure, beyond the reach of traditional network scanners. For example, systems are configurable to detect application-layer vulnerabilities such as SQL injection, cross-site scripting, remote code execution, and others, which are pivotal for safeguarding against high and critical-risk threats.

Moreover, these systems are configurable to conduct scanning and tracking of dangerous ports and risky services, including remote desktop protocol (RDP), SQL, file transfer protocol (FTP), and so on, which are commonly exploited through brute force and credential stuffing attacks for unauthorized access. The systems are configurable to provide subdomain enumeration and discovery to uncover new and existing Internet-exposed systems, which can reveal numerous applications hosted on a single IP address, far exceeding the capabilities of conventional network vulnerability scanning.

Furthermore, these systems are configurable to provide application directory enumeration to detect publicly accessible sensitive files, alongside a managed vulnerability validation and publication process, ensuring only verified critical and high-risk vulnerabilities are reported to clients. These systems are also configurable to address the challenge of managing domain name service (DNS) records for subdomains by identifying stale records that could be hijacked by threat actors. These systems are configurable to review archived Internet data for exposed sensitive information, evaluate Storage-as-a-Service (SaaS) containers for unsecured client data, and identify application backdoors for maintaining unauthorized access.

In addition to remediation support, these systems are configurable to provide a dashboard for comprehensive data analysis and visualization, credential stuffing and password spraying services to test against public breaches, and certificate health and compliance monitoring to ensure encryption standards are met. These systems are also configurable to identify and interrogate unindexed application programming interface (API) endpoints for vulnerabilities and searches public source code repositories for exposed sensitive information, enhancing an organization's defense against sophisticated cyber threats.

While the subject matter described herein is presented, at times, in the general context of program modules that execute in conjunction with the execution of an operating system and application programs on a computer system or multiple computer systems, those skilled in the art will recognize that other implementations may be performed in combination with other types of program modules. Program modules include routines, programs, components, data structures, and other types of structures that perform particular tasks or implement particular data types. Moreover, those skilled in the art will appreciate that the subject matter described herein may be practiced with other computer system configurations, including virtual machines, virtual compute instances, database instances, hand-held devices, multiprocessor systems, microprocessor-based or programmable consumer electronics, minicomputers, mainframe computers, and the like.

In the following detailed description, references are made to the accompanying drawings that form a part hereof, and in which are shown by way of illustration specific implementations or examples. Referring now to the drawings, in which like numerals represent like elements throughout the several figures, aspects of a system, a computer-readable storage medium, and a computer-implemented methodology for continuously assessing external risk for Internet-facing assets will be presented.

### Example Operating Environment

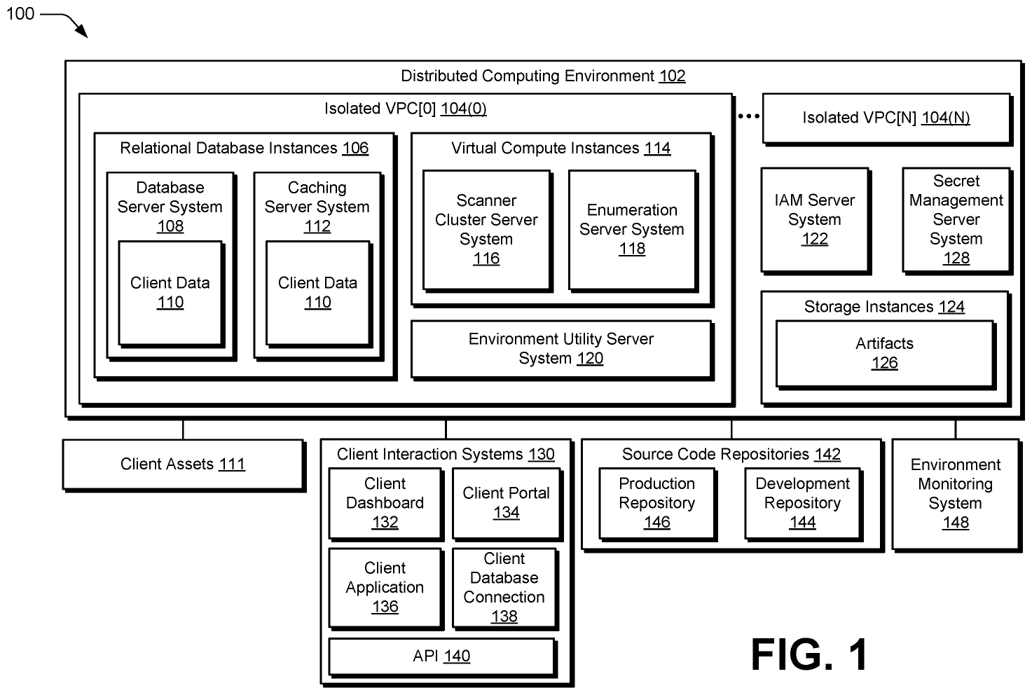

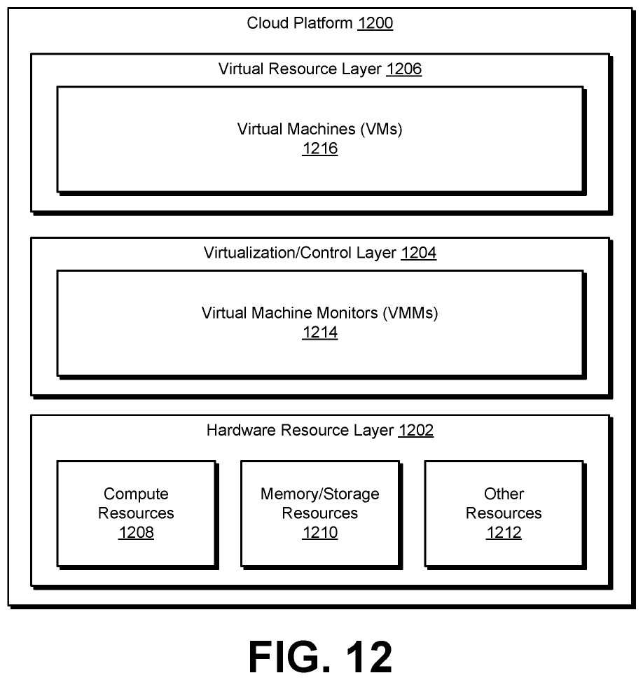

FIG. 1 depicts an operating environment 100 in an example implementation that is operable to employ concepts and technologies described herein for continuously assessing external risk for Internet-facing assets. The illustrated operating environment 100 includes a distributed computing environment 102 that is deployed by a security service provider on a cloud computing platform. Although one distributed computing environment 102 is shown, the concepts and technologies described herein can be implemented via multiple distributed computing environments 102. The distributed cloud computing environments 102 can be deployed using cloud computing platforms that are commercially available, proprietary cloud computing platforms, or a combination of both. Briefly, these cloud computing platforms provide access to computing resources, storage resources, other resources, and services to implement aspects of the concepts and technologies described herein via the distributed computing environment 102. A simplified example of a cloud platform is illustrated and described herein with reference to FIG. 12.

In the illustrated example, the distributed computing environment 102 is shown having multiple isolated virtual private clouds (VPCs) 104(0)-104(N). Each VPC 104 can provide cloud computing resources within a secure, isolated segment of the distributed computing environment 102 in which to deploy a client-specific implementation of the concepts and technologies described herein for continuously assessing external risk for Internet-facing assets. In this manner, a security service provider can create one or more VPCs 104 for each client.

An example VPC 104 is shown having one or more relational database instances 106. The relational database instances 106 provide a database server system 108 configured to store and manage client data 110 associated with client assets 111 in a structured format using tables that are interconnected through relationships. The number of relational database instances 106 can be increased or decreased as needed to accommodate the amount of capacity needed to store the client data 110. The client data 110 includes all data captured by the security service provider in association with a specific client. The client data 110 is written to and read from the database server system 108 as needed. The database server system 108 can be implemented using a conventional or proprietary relational database management system to manage operation of the database server system 108, including performance of operations such as querying, inserting, updating, deleting, and/or otherwise interacting with all or portions of the client data 110. In one or more examples, the database server system 108 can be implemented using a SQL-based relational database management system.

The relational database instances 106 also include, in some implementations, a caching server system 112 configured to cache portions of the client data 110 to increase data retrieval speeds and to reduce latency associated with reading data from disk-based databases (e.g., the database server system 108 in some implementations). The caching server system 112 can temporarily store frequently accessed portions of the client data 110, such as results of database queries or computations, so that future requests for the same data can be served faster without the need to repeat the underlying database query or computation. The caching server system 112, in some implementations, is or includes a remote dictionary server (Redis).

The database server system 108 and the caching server system 112 are shown as part of the same relational database instance 106. In alternative implementations, multiple relational database instances 106 are instantiated, such as one relational database instance 106 for the database server system 108 and another relational database instances 106 for the caching server system 112. In other implementations, functionality of the database server system 108 and the caching server system 112 is combined as part of a single server system. In still other implementations, the database server system 108 is deployed without the caching server system 112. In alternative implementations, a single relational database instance 106 host multiple database server systems 108.

The isolated VPC 104 also includes one or more virtual compute instances 114. Each virtual compute instance 114 is a virtualized environment provisioned within a physical server's resources, utilizing a hypervisor to emulate hardware. The virtual compute instances 114 operate with allocated virtual processing cores, memory, storage, and network interfaces, allowing the virtual compute instances 114 to run their own operating system and applications independently of other instances. This architecture enables efficient resource utilization, scalability, and isolation, facilitating flexible and cost-effective cloud computing services.

In the illustrated example, the virtual compute instances 114 are used to implement a scanner cluster server system 116. The scanner cluster server system 116 can implement any number of scanner server instances to perform network and application layer scans across all the client assets 111 that are considered in-scope for the client associated with the isolated VPC 104. The client assets 111 that are “in-scope” refer to assets to be assessed in accordance with the concepts and technologies described herein or some functionality thereof based upon one or more agreements such as service level agreements (SLAs) between the security service provider and client that owns, operates, and/other otherwise has a vested interest in the security of the client assets 111.

In one or more implementations, the number of virtual compute instances 114 that include at least one scanner cluster server system 116 is determined based on the number of client assets 111 to be protected. New instances of the scanner cluster server system 116 can be instantiated as needed. Likewise, existing instances of the scanner cluster server system 116 can be deactivated when no longer needed.

The virtual compute instances 114 also include an enumeration server system 118. The enumeration server system 118 discovers what client assets 111 are associated with the client. For example, the enumeration server system 118 discovers the systems, domains, and sub-domains associated with the client. In one or more implementations, the enumeration server system 118 is configured to perform sub-domain fuzzing to systematically generate and query a set of possible sub-domain names against a target domain to identify valid, potentially unlisted or forgotten sub-domains. More particularly, the enumeration server system 118 can use automated tools that leverage dictionaries, common naming conventions, and patterns to generate sub-domain names, which are then checked via DNS queries to discover which ones resolve to active IP addresses. In one or more implementations, the enumeration server system 118 is configured to perform search engine dorking to find specific information or vulnerabilities within websites associated with the client. These queries can exploit the vast indexing power of search engines to uncover sensitive information, misconfigured websites, or even security vulnerabilities that are otherwise difficult to find through conventional browsing methods. In one or more implementations, the enumeration server system 118 validates the state of systems, ports, and security controls.

The VPC 104 also includes an environment utility server system 120. The environment utility server system 120 monitors operations performed by the various systems in the VPC 104 to ensure services are operating correctly, the resources allocated to the systems are not being under or overutilized, and/or the overall “health” conditions of the relational database instances 106 and the virtual compute instances 114 within the VPC 104.

The scanner cluster server system 116 and the environment utility server system 120 can communicate with an identity and access management (IAM) server system 122. The IAM server system 122 manages digital identities and their access rights within an organization, such as the security service provider. The server system 122 encompasses the technologies, policies, and processes required to authenticate and authorize users to access specific resources based on predefined roles, permissions, and policies. The IAM server system 122 can implement features such as single sign-on (SSO), multi-factor authentication (MFA), and directory services to streamline and secure user access. The IAM server system 122 manages the entire user lifecycle, from onboarding to offboarding, including changes in roles and access privileges. Additionally, the IAM server system 122 provides audit and compliance reporting capabilities, enabling the security service provider to monitor access patterns, enforce security policies, and comply with regulatory standards. By effectively managing user identities and controlling access to resources, the IAM server system 122 is capable of mitigating unauthorized access and data breaches, enhancing organizational security and compliance.

The distributed computing environment 102 also includes one or more storage instances 124 configured to store artifacts 126 collected as part of the various services performed by the systems within the VPC 104, such as the discovery service performed by the enumeration server system 118. The artifacts 126 broadly encompass any piece of data or digital object that can be used to detect, analyze, or provide evidence about a potential or actual security incident, threat, or vulnerability associated with the client assets 111. The artifacts 126 can include, for example, a wide range of items, such as files, file fragments, system logs, network packets, uniform resource locators (URLs), domain names, sub-domain names, code, binaries, and so on.

The distributed computing environment 102 also includes a secret management server system 128 that securely stores and manages sensitive information such as passwords, API keys, and certificates. The secret management server system 128 tightly integrates with the with the IAM server system 122 to control access to these secrets through robust authentication and authorization processes. IAM policies specify which users or services can access or manage secrets, ensuring only authorized entities are granted access based on their authenticated identity and predefined permissions. This integration facilitates secure, auditable access to sensitive credentials, supporting compliance and enhancing overall security by leveraging centralized identity verification, access control mechanisms, and detailed audit logs for monitoring and reviewing access to secrets.

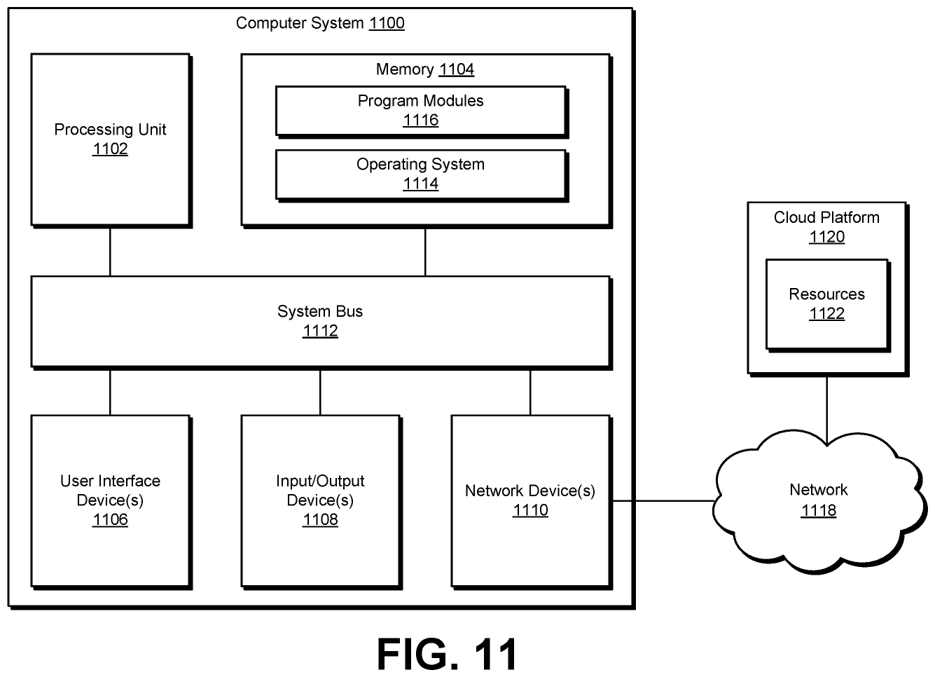

Clients can interact with their respective VPC(s) 104 via one or more client interaction systems 130. The client interaction systems 130 can interact with the VPC(s) 104 through several methods, each offering different levels of connectivity, security, and performance. The client interaction systems 130 can implement one or more client dashboards 132, one or more client portals 134, one or more client applications 136, one or more client database connections 138, one or more APIs 140, or any combination thereof. In one or more implementations, the client interaction systems 130 can include computing systems, such as a tablet computing device, a personal computer (“PC”), a desktop computer, a laptop computer, a notebook computer, a cellular phone or smartphone, other mobile computing devices, a personal digital assistant (“PDA”), or the like. An example architecture of the client interaction system 130 is illustrated and described below with reference to FIG. 11.

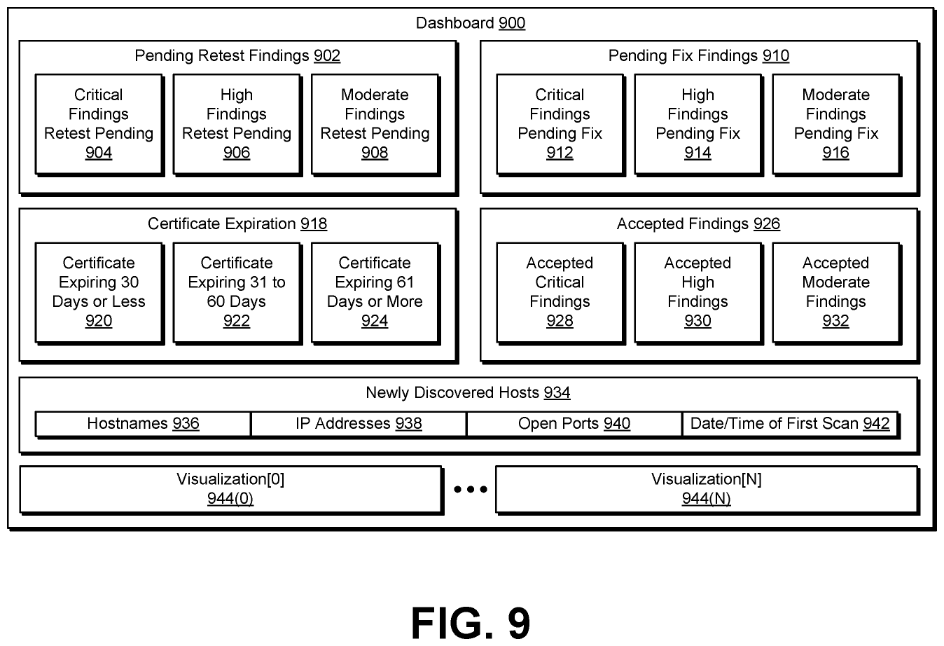

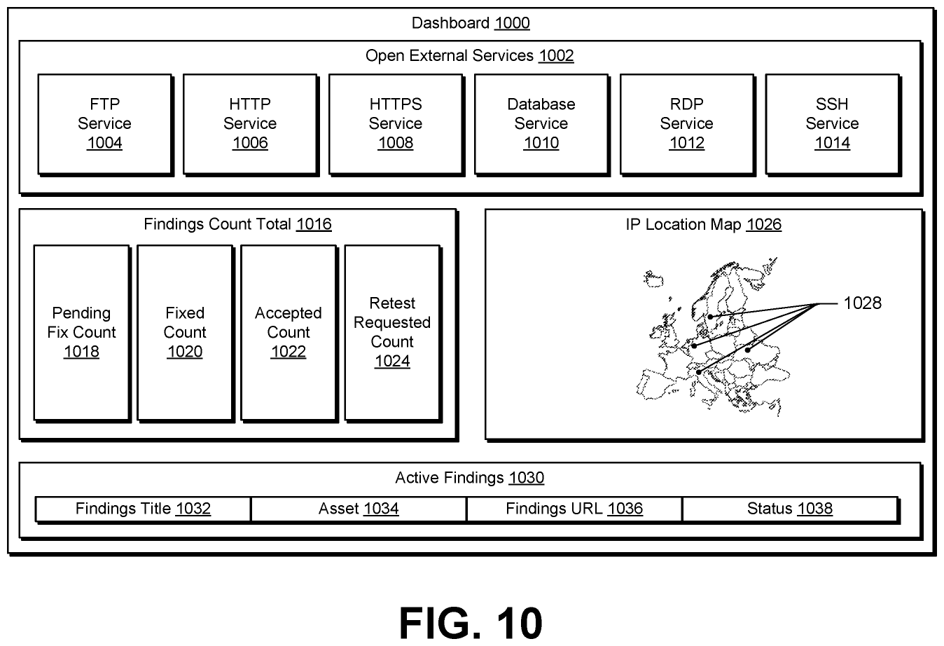

The client dashboard 132 is a user interface designed to provide clients or users with an overview of key information, metrics, and performance indicators relevant to their specific needs or objectives. The client dashboard 132 is accessible through a web application or software platform. The client dashboard 132 aggregates and visualizes data in an easily digestible format, using charts, graphs, tables, widgets, and/or other visualizations. The purpose of the client dashboard 132 is to offer real-time (or near-real-time) insights into various aspects of the client assets 111, enabling clients to make informed decisions, track progress, and identify trends or issues promptly. Features of the client dashboard 132 can include customizable views, interactive elements (such as drill-down capabilities), and alerts or notifications about critical metrics or milestones. Example implementations of the client dashboard 132 are illustrated and described herein with reference to FIGS. 9 and 10.

The client portal 134 is a secure, online platform that provides clients with personalized access to services, resources, and information related the security service(s) provided via their corresponding VPC 104. The client portal 134 serves as a centralized hub where clients can access important data, communicate with the security service provider, manage their accounts, and perform transactions or requests online. The client portal 134 can include secure login mechanisms, document management (uploading and downloading), messaging or ticketing systems for communication, account management tools.

The client application 136 is a software program that runs on a user's device, such as a computer, smartphone, or tablet, designed to access and interact with the isolated VPC 104. The client application 136 serves as the interface between the user (client) and the service provider's systems, including the database server system 108, the caching server system 112, the scanner cluster server system 116, and/or the enumeration server system 118, enabling the execution of various tasks like retrieving data, submitting forms, conducting transactions, or communicating with other users with the organization. The client application 136 can be a web browser implementing a web application or a native application designed to run on the client interaction systems 130.

The client database connection 138 enables direct communication with the relational database instances 106, including the database server system 108 and/or the caching server system 112 to perform operations such as querying, updating, or managing the client data 110 or portions thereof. The client database connection 138 is facilitated by database drivers or libraries that implement the protocols needed to communicate with the DBMS used by the database server system 108 and/or the caching server system 112. The process involves specifying the database server's address (e.g., a URL or IP address), authentication credentials (username and password), and, in some implementations, the specific database name or schema to be accessed.

Once established, the connection allows the client application to execute SQL commands or database-specific queries to interact with the stored data. The database server processes these requests and returns the results to the client application, which can then present the data to the user or perform further operations. Managing a client database connection also involves handling aspects like connection pooling (to efficiently reuse connections), transaction management (to ensure data integrity), and error handling (to deal with issues that arise during data operations).

The API 140 is a set of protocols, routines, and tools that enable a client (software application) to communicate with the VPC 104 and systems thereof. The API 140 can be used to retrieve, view, and manipulate the client data. The API 140 can be implemented as a representational state transfer (RESTful) API, a simple object access protocol (SOAP) API, a GraphQL API, a proprietary API, or the like.

The operating environment 100 also includes source code repositories 142 that provide a central file storage location where developers (e.g., the security service provider) store and manage their source code, along with various other project files such as documentation, configurations, and dependencies. The source code repositories 142 act, in part, as version control systems (VCS), enabling multiple developers to collaborate on software development projects regardless of their geographical location. The source code repositories 142 enable developers to track changes, manage versions, and facilitate continuous integration and delivery processes within the distributed computing environment 102. The source code repositories 142 support various operations like branching, merging, and reverting, which are crucial for managing different development stages and ensuring that changes can be made in a controlled and reversible manner.

In the illustrated example, the source code repositories 142 include a development repository 144 and a production repository 146. The segregation of source code into production and development repositories maintains the software development lifecycle, ensuring that new developments can proceed unhindered and without affecting the production environment, which meanwhile remains stable and secure for the end-users.

The development repository 144 is used during the development phase, where new features, fixes, and updates are actively developed and tested. The development repository 144 is a more dynamic environment compared to the production repository 146, allowing for rapid iteration and experimentation. Developers commit their changes to the development repository 144, where code is reviewed, tested, and integrated with existing features. The development repository 144 serves as the staging ground for all new developments before they are deemed stable enough to be merged into the production repository 146. The development repository 144 facilitates collaboration among development teams, enabling these teams to work on different aspects of the project concurrently, merge their contributions, resolve conflicts, and ensure that the code is thoroughly tested in an integrated environment before promoting it to the production level.

The production repository 146 refers to the source code repository that holds the codebase currently in use in the production environment, i.e., the isolated VPC 104. In other words, the production repository 146 stores the version of the software that is live and operational to perform the various operations described herein. The production repository 146 maintains the integrity and stability of the production environment by implementing the most recent, fully tested, and approved version of the source code. Access to the production repository 146 is tightly controlled, with strict policies governing who can merge code into the production repository 146 from the development repository 144 and under what conditions. In this manner, unauthorized or untested changes that could disrupt the production environment are avoided. In some implementations, the source code repositories 142 employ continuous integration tools to pull the latest stable version from the production repository 146 to build, test, and deploy a resource (e.g., an instance of the scanner cluster server system 116 or the enumeration server system 118) in an automated manner, ensuring that the production environment is always running a verified and stable codebase.

The operating environment 100 also includes a distributed computing environment monitoring system 148. The distributed computing environment monitoring system 148 is configured to oversee and manage the performance, health, and availability of various components within the distributed computing environment 102. This includes servers, networks, applications, and services spread across multiple physical and virtual environments, potentially spanning different geographical locations. The distributed computing environment monitoring system 148 ensures that the distributed infrastructure operates at optimal efficiency, with minimal downtime and performance degradation, by proactively detecting, reporting, and resolving issues.

The distributed computing environment monitoring system 148 operates by collecting a wide array of metrics and logs from the distributed computing environment 102. These can include processor (compute) usage, memory (storage) consumption, disk I/O, network bandwidth, application response times, and error rates, among others. This data can be aggregated, analyzed, and visualized in real-time dashboards, providing administrators and operations teams of the security service provider with a comprehensive view of the entire distributed computing environment's health and performance. In some implementations, the distributed computing environment monitoring system 148 employs machine learning algorithms to predict potential failures or bottlenecks before any impact to the distributed computing environment 102, allowing for preemptive action.

In addition to real-time monitoring, the distributed computing environment monitoring system 148 can provide alerting mechanisms that notify relevant personnel via email, text message, or other communication channels when predefined thresholds are breached, indicating potential issues that require attention. This facilitates swift response to incidents, minimizing downtime and ensuring service continuity. Moreover, the distributed computing environment monitoring system 148 can support historical data analysis, enabling the security service provider to identify trends, plan for capacity upgrades, and optimize resource allocation based on usage patterns.

### Example Scanner Cluster Server System

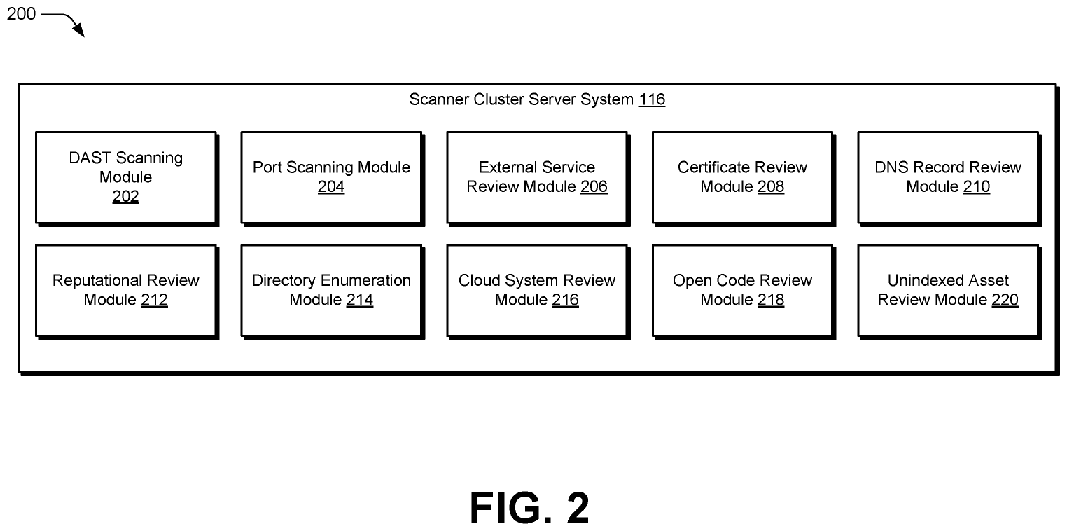

FIG. 2 depicts the scanner cluster server system 116 in an example implementation 200 that is operable to employ concepts and technologies described herein. In the implementation 200, the scanner cluster server system 116 includes a DAST scanning module 202, a port scanning module 204, an external service review module 206, a certificate review module 208, a DNS record review module 210, a reputational review module 212, a directory enumeration module 214, a cloud system review module 216, an open code review module 218, and an unindexed asset review module 220. These modules can be implemented as part of a single scanner cluster server application executed by compute resources of the virtual compute instances 114. Alternatively, these modules can be executed, separately or in any combination, by compute resources of the virtual compute instances 114. For instance, one scanner cluster server system 116 can be configured to execute a first set of one or more modules, and another scanner cluster server system 116 can be configured to execute a second set of one or more modules.

The DAST scanning module 202 is configured to identify security vulnerabilities in web applications while the web applications are running. The DAST scanning module 202 simulates external attacks to detect issues like SQL injection, cross-site scripting, and other vulnerabilities that could be exploited by attackers. The DAST scanning module 202 helps in assessing the application from an attacker's perspective, ensuring runtime security analysis.

The port scanning module 204 is configured to systematically scan ports (e.g., of systems included in the client assets 111) to identify open ports and the services running on the open ports. This information can be used for understanding the attack surface of a system because open ports can indicate potential entry points for attackers. The port scanning module 204 enables security assessments by mapping out network services, identifying unauthorized services, and flagging potential vulnerabilities.

The external service review module 206 is configured to evaluate external third-party services integrated with the client assets 111 for security risks. The external service review module 206 checks for misconfigurations, outdated versions, and known vulnerabilities in services like APIs, content delivery networks, or cloud-based storage, ensuring that external dependencies do not introduce security weaknesses.

The certificate review module 208 is configured to analyze the secure sockets layer (SSL) and transport layer security (TLS) certificates used by applications and services associated with the client assets 111 to ensure encrypted communication. The certificate review module 208 checks for validity, expiration, and compliance with encryption standards. In this manner, the certificate review module 208 helps in preventing security issues related to certificate mismanagement, such as man-in-the-middle attacks and denial of service conditions.

The DNS record review module 210 is configured to review DNS records associated with the organization to identify misconfigurations or stale records that could be exploited for DNS hijacking or to redirect traffic to malicious sites. The DNS record review module 210 ensures that DNS records are effectively managed and updated to maintain domain integrity preventing security issues such as account spoofing and subdomain takeovers.

The reputational review module 212 is configured to assess the reputation of domains, IP addresses, and external services associated with the organization. The reputational review module 212 uses various databases and threat intelligence sources to identify if any of the client assets 111 are listed as malicious or have been involved in suspicious activities, helping to mitigate potential reputational damage. Additionally, the reputational review module 212 uses dynamically created key term or phrase lists associated with the client to identify open storage, unusually deployed web content, historical issues, and misuse of URL shorteners.

The directory enumeration module 214 is configured to scan web applications to list directories and files that are publicly accessible. The directory enumeration module 214 is configured to identify sensitive files, established system backdoors, and directories accidentally exposed to the public, which could lead to information disclosure or unauthorized access. The directory enumeration module 214 also aids in tightening access controls and ensuring sensitive data is not inadvertently exposed.

The cloud system review module 216 specifically targets cloud-based environments to assess their configuration, security settings, and compliance with best practices. The cloud system review module 216 evaluates storage buckets, virtual machines, databases, and other cloud resources for misconfigurations, excessive permissions, and other security risks, ensuring that cloud deployments are secure and resilient against attacks. Additionally, the cloud system review module 216 identifies externally available resources and appends these resources to the client assets 111.

The open code review module 218 specifically targets open code bases that have terms or phrases associated with the client or client assets 111 and identifies code contributors (e.g., via one or more identifiers) who are associated with the client organization. Additionally, the open code review module 218 searches for code bases with leaked or misused sensitive information, credentials, tokens or keys, tightening access controls, and ensuring sensitive data is not inadvertently exposed.

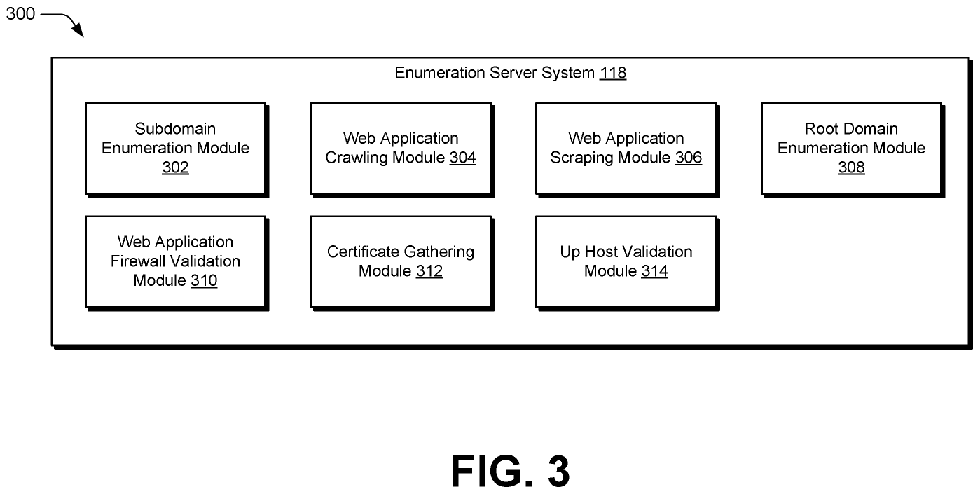

FIG. 3 depicts the enumeration server system 118 in an example implementation 300 that is operable to employ concepts and technologies described herein. In the implementation 300, the enumeration server system 118 includes a subdomain enumeration module 302, a web application crawling module 304, a web application scaping module 306, a root domain enumeration module 308, a web application firewall validation module 310, a certificate gathering module 312, and an up host validation module 314. These modules can be implemented as part of a single enumeration server system 118 executed by compute resources of the virtual compute instances 114. Alternatively, these modules can be executed, separately or in any combination, by compute resources of the virtual compute instances 114. For instance, one enumeration server system 118 can be configured to execute a first set of one or more modules, and another enumeration server system 118 can be configured to execute a second set of one or more modules.

The subdomain enumeration module 302 is configured to discover and list all subdomains associated with a target domain. The subdomain enumeration module 302 employs various techniques, including DNS queries, brute force methods using dictionaries of common subdomain names, and scraping web pages for links and references to uncover hidden or undocumented subdomains. The subdomain enumeration module 302 can identify potentially vulnerable entry points in an organization's network that are not immediately obvious, enabling a more comprehensive security assessment of the organization's digital footprint.

The web application crawling module 304 is configured to systematically navigate through web applications to map out their structure and discover all accessible pages and resources. Utilizing automated bots or crawlers, the web application crawling module 304 follows links within a web application, identifying content, functionality, and the underlying directory structure. The gathered information can be used for understanding the application's layout, preparing for more in-depth security analyses, such as vulnerability scanning or penetration testing, and ensuring no part of the application is overlooked in security assessments.

The web application scaping module 306 is configured to extract specific data from web applications. Unlike the broader approach of crawling (e.g., via the web application crawling module 304), scraping is targeted, aiming to retrieve particular information such as contact details, prices, or any data presented in a structured format on the web pages. The web application scaping module 306 can be used for gathering intelligence, monitoring for content changes, or aggregating data from multiple sources for analysis. The web application scaping module 306 can help identify exposed sensitive information or monitor for unauthorized changes to web content.

The root domain enumeration module 308 is configured to identify all the root domains owned or controlled by an organization. This comprehensive identification goes beyond subdomain enumeration by cataloging the primary domains under which subdomains and various services operate. The root domain enumeration module 308 is configured to analyze DNS records, WHOIS data, and leverage databases that track domain registrations. Identifying all root domains ensures that security policies and protections are uniformly applied across an organization's entire web presence, safeguarding against oversights that could lead to vulnerabilities.

The web application firewall validation module 310 is configured to identify if a web application firewall is present and, if so, whether the web application firewall is functioning as expected. This validation is conducted at the system and directory levels to identify inconsistent deployments of web application firewalls.

The certificate gathering module 312 identifies and tracks certificates installed on applications associated with the client assets 111. The certificates are tracked and updated within client data 110 within the database server system 108.

The host up validation module 314 validates current state of systems, applications, ports, and content and tracks changes. This enables real time tracking of states within the client dashboard 132.

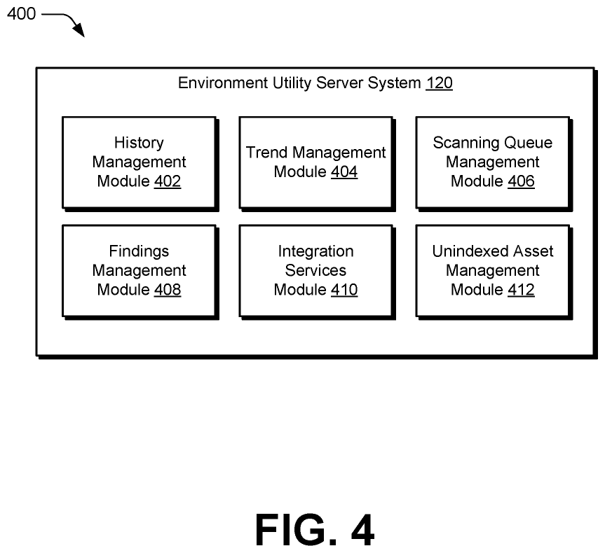

FIG. 4 depicts the environment utility server system 120 in an example implementation 400 that is operable to employ concepts and technologies described herein. In the implementation 400, the environment utility server system 120 includes a history management module 402, a trend management module 404, a scanning queue management module 406, a findings management module 408, an integration services module 410, and an unindexed asset management module 412. These modules can be implemented as part of a single environment utility server system 120. In some implementations, the environment utility server system 120 is provided, at least in part, by compute resources of the virtual compute instances 114 or other similar resources. Alternatively, the environment utility server system 120 is a standalone physical server. In either case, the environment utility server system 120 is configured to execute the aforementioned modules to perform various operation for the VPC 104.

The history management module 402 is configured to record and maintain a comprehensive log of all activities and changes within the client assets 111 and client related data. The history management module 402 is configured to track the history of configurations, deployments, security scans, and any modifications made across the client assets 111, enabling clients to review past states, audit changes, and identify issues by understanding the sequence of events leading to the current state. The history management module 402 provides functionality for accountability, compliance, and historical analysis.

The trend management module 404 is configured to analyze historical data collected over time to identify patterns, trends, and anomalies within the client assets 111 and client data exposed externally. By leveraging data analytics and machine learning algorithms, the trend management module 404 can forecast potential issues and suggest improvements based on observed behavior. The trend management module 404 enables proactive capacity planning, performance optimization, and risk management, allowing for data-driven decisions to enhance client security posture.

The scanning queue management module 406 is configured to orchestrate the scheduling, execution, and prioritization of scanning tasks across the VPC 104. The scanning queue management module 406 ensures that resources are efficiently utilized, scans are performed systematically, and the impact on performance is minimized. The scanning queue management module 406 also facilitates the dynamic allocation of scanning tasks based on system load, priority of assets, and vulnerability criticality, streamlining the scanning process for optimal coverage and timeliness.

The findings management module 408 is configured to aggregate, categorize, and manage findings from various scans, audits, and assessments performed within the VPC 104. The findings management module 408 provides a centralized repository for all security findings, vulnerabilities, compliance issues, and system insights, enabling prioritization, assignment, and tracking of remediation efforts. The findings management module 408 enhances the visibility of security and compliance status, supports efficient workflow management for addressing issues, and provides reporting capabilities for stakeholders.

The integration services module 410 facilitates seamless communication and data exchange between the environment utility server system 120 and other tools, services, or platforms within the distributed computing environment 102. The integration services module 410 supports a range of protocols and APIs to connect with cloud services, security tools, monitoring systems, and operational databases, enabling a cohesive and automated workflow. The integration services module 410 ensures that the environment utility server system 120 can leverage and augment the capabilities of existing solutions, fostering a unified and efficient management approach across the VPCs 104.

The unindexed asset management module 412 facilitates the scanning and processing of systems, services, and assets that are outside of normal operational functions. The unindexed asset management module 412 is configured to address assets or systems that fall outside of the client asset 111 normal model, however, is still within scope to be reviewed, scanned, or addressed by the various scans, audits, and assessments performed within the VPC 104.

### Asset Discovery

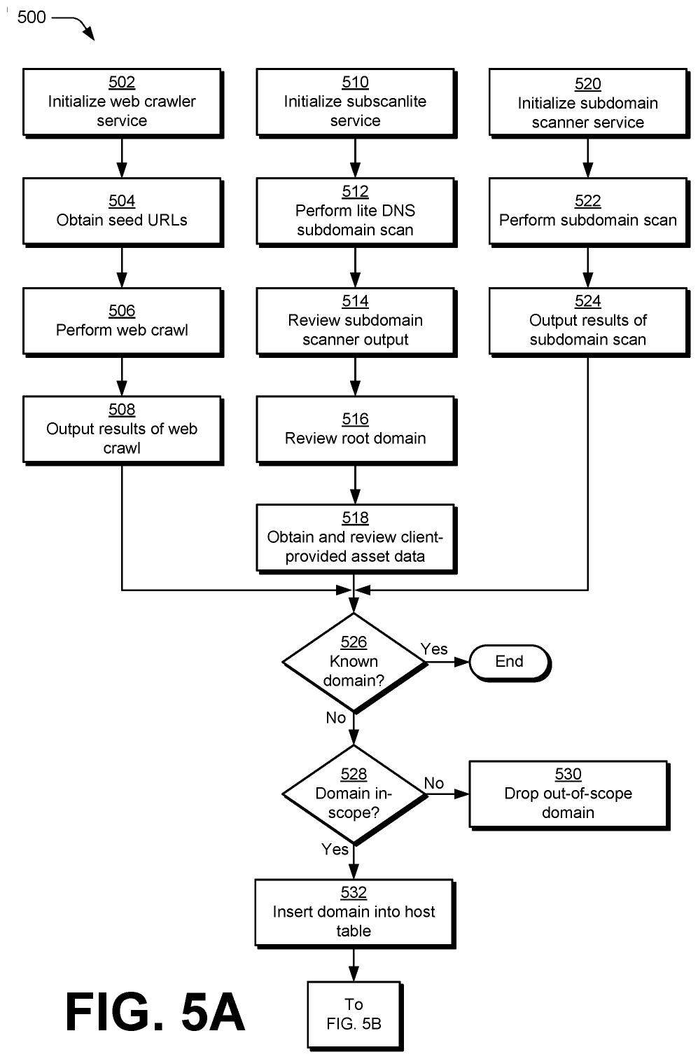

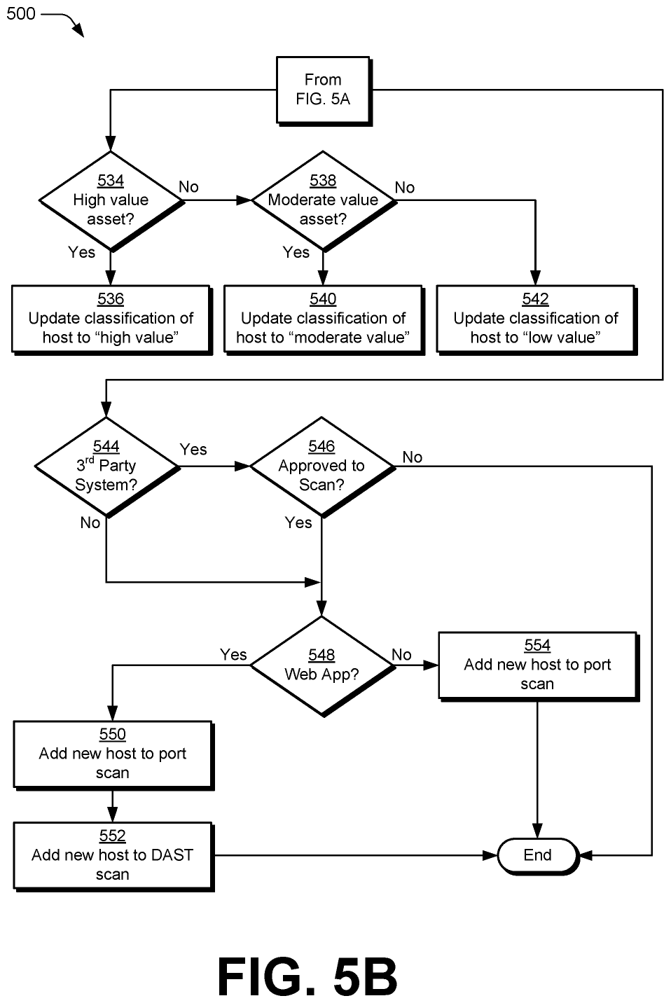

FIGS. 5A-5B depict a flow diagram of a method 500 for asset discovery according to an example implementation. It should be understood that the operations of the methods disclosed herein are not necessarily presented in any particular order and that performance of some or all of the operations in an alternative order(s) is possible and is contemplated. The operations have been presented in the demonstrated order for ease of description and illustration. Operations may be added, omitted, and/or performed simultaneously, without departing from the scope of the appended claims.

It also should be understood that the illustrated methods disclosed herein can be ended at any time and need not be performed in their respective (or collective) entireties. Some or all operations of the methods disclosed herein, and/or substantially equivalent operations, can be performed by execution of computer-readable instructions included on a computer-storage media, as defined herein. The term “computer-readable instructions,” and variants thereof, as used in the description and claims, is used expansively herein to include routines, applications, application modules, program modules, programs, components, data structures, algorithms, and the like. Computer-readable instructions can be implemented on various system configurations, including single-processor or multiprocessor systems, minicomputers, mainframe computers, personal computers, hand-held computing devices, microprocessor-based, programmable consumer electronics, combinations thereof, and the like.

Thus, it should be appreciated that the logical operations described herein are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states, operations, structural devices, acts, or modules. These operations, structural devices, acts, and modules may be implemented in software, in firmware, in special purpose digital logic, and any combination thereof.

For purposes of illustrating and describing the concepts and technologies of the present disclosure, the methods disclosed herein are described as being performed generally by one or more virtual compute instances 114 implemented as one or more scanner cluster server systems 116 and/or one or more enumeration server systems 118 via execution of one or more software modules such as, for example, the DAST scanning module 202, the port scanning module 204, the external service review module 206, the certificate review module 208, the DNS record review module 210, the reputational review module 212, the directory enumeration module 214, the cloud system review module 216, the subdomain enumeration module 302, the web application crawling module 304, the web application scaping module 306, the root domain enumeration module 308, or a combination thereof.

It should be understood that additional and/or alternative systems, devices, and/or network nodes can provide the functionality described herein via execution of one or more modules, applications, and/or other software including, but not limited to, the aforementioned modules. Thus, the illustrated implementations are illustrative, and should not be viewed as being limiting in any way.

The method 500 will be described from the perspective of the enumeration server system 118 executing one or more of the modules described in detail above. It is contemplated that some of the operations of the method 500 can be performed by a single instance of the enumeration server system 118 or multiple instances of the enumeration server system 118. In case of the latter, the instances of the enumeration server system 118 can operate on the same or different virtual compute instances 114, which may operate on the same or different physical hardware.

The method 500 begins when services are started. In the illustrated example, the enumeration server system 118 initializes a web crawler service (block 502). This includes loading the crawler's configuration settings, such as crawl depth, page visit limits, user-agent strings, and politeness policies (i.e., to avoid overloading web servers). The crawler service allocates resources, initiates data processing modules, and sets up necessary connections to databases or storage systems where the crawl results will be stored, such as the database server system 108, the caching server system 112, and/or the one or more storage instances 124 as the case may be.

The enumeration server system 118 then obtains seed URLs (block 504). Seed URLs serve as the starting points for the web crawl. The crawler service obtains these URLs, which can be manually specified by a user, derived from a predefined list, obtained from a previous crawl's output, or any combination thereof. The URL seeds direct the crawler towards relevant parts of the web, ensuring that the crawling process is aligned with the objectives of the service (e.g., focusing on a specific domain or topic area).

After the enumeration server system 118 obtains the seed URLs, the enumeration server system 118 uses the seed URLs as starting points to perform the web crawler service (block 506). The web crawler service includes a fetching operation during which the crawler sends HTTP requests to retrieve the content of each seed URL. The web crawler service uses text files (e.g., robots.txt) to ensure compliance with site-specific crawling restrictions (if any). The web crawler service also includes a parsing operation during which the crawler parses the HTML content to extract links to other pages and relevant data as per its configuration (e.g., text, images, metadata, and so on). The web crawler service also includes a URL extraction and deduplication operation during which the web crawler service extracts new URLs from the links found in the parsed content. The web crawler service then performs deduplication, ensuring that each URL is only visited once, to avoid redundant crawling and reduce the workload.

The web crawler service follows the extracted links (up to a specified depth) and repeats the fetching and parsing operations for each new page, broadening the crawl. This process continues recursively, expanding from the seed URLs throughout the web or within the specified scope.

In some implementations, the web crawler service is configured to adhere to politeness policies, which manage request rates to prevent overloading web servers. The web crawler service can randomize visit intervals and respect any “crawl-delay” directive in a robots.txt or similar file.

After the web crawl is performed, the enumeration server system 118 outputs the results of the web crawl (block 508). In particular, data (e.g., page content, structured data, links) extracted during the web crawl is processed according to one or more goals. This may involve cleaning, normalization, and analysis of the data. The processed data, along with metadata about the crawl (e.g., time stamps, source URLs, and HTTP status codes), is stored in a database or file storage system, such as the database server system 108, the caching server system 112, and/or the one or more storage instances 124. In some implementations, the enumeration server system 118 also generates, as part of the web crawler service, reports or summaries of the crawl, detailing metrics such as the number of pages visited, data volume collected, and any errors encountered. This information is useful for evaluating the crawl's effectiveness and planning future crawls.

The enumeration server system 118 also initializes a SubscanLite service (block 510). This involves setting up the necessary configurations, such as specifying the target domains, defining scan parameters (e.g., scan depth, concurrency limits), and preparing the system resources. The SubscanLite service may also load any required DNS resolution libraries or APIs that will be used during the scanning process.

Briefly, the SubscanLite service performs lightweight DNS subdomain scans and aggregates information on a target domain's digital assets, such as the client assets 111. This streamlined approach helps in identifying subdomains and evaluating the security posture of both subdomains and the root domain, utilizing client-provided asset data for a comprehensive analysis.

The enumeration server system 118 can initialize the SubscanLite service to operate simultaneously with the web crawler service, before the web crawler service, or after the web crawler service. Moreover, one instance of the enumeration server system 118 may be configured to implement the web crawler service and a second instance of the enumeration server system 118 may be configured to implement the SubscanLite service.

The enumeration server system 118 then performs a lite DNS subdomain scan (block 512). First, the SubscanLite service queries DNS records to discover subdomains associated with the target root domain. This might involve using standard DNS queries, as well as leveraging various public DNS databases and passive DNS search engines to uncover known subdomains. Second, the SubscanLite service employs lightweight enumeration techniques, utilizing a predefined list of common subdomain names to check against the target domain, identifying active subdomains without intensive brute-forcing. Last, the SubscanLite service validates discovered subdomains to ensure these subdomains are active and correctly resolve to IP addresses, filtering out any stale or non-responsive entries.

The enumeration server system 118 then reviews subdomain scanner output (block 514). The output from the subdomain scan (block 512) is analyzed to categorize subdomains by type, purpose, and/or security posture, identifying potential areas of interest or concern, such as development, staging, or deprecated services. The subdomains also may be prioritized for further investigation based on factors like criticality to business operations, known vulnerabilities, exposure to the Internet, and/or other relevant factors.

The enumeration server system 118 then reviews the root domain (block 516). In particular, the root domain undergoes a security assessment to identify misconfigurations, insecure DNS settings, or vulnerabilities that could affect the entire domain. The enumeration server system 118 also ensures that DNS records for the root domain are consistent and properly configured, looking for issues like missing Sender Policy Framework (SPF) or Domain-based Message Authentication Reporting and Conformance (DMARC) records which could impact email security.

After the enumeration server system 118 reviews the root domain, the enumeration server system 118 obtains and reviews client-provided asset data about the client assets 111 (block 518). Client-provided data regarding known assets, network infrastructure, and any previous security findings are integrated into the analysis to provide context and enhance the understanding of the domain's security posture. The SubscanLite service cross-references discovered subdomains and root domain data with the client-provided asset data to identify discrepancies, newly discovered assets, or previously unknown vulnerabilities. Additionally, a comprehensive report is generated, summarizing the findings from the DNS subdomain scan (blocks 512, 514), root domain review (block 516), and the analysis of client-provided asset data (block 518).

The enumeration server system 118 also initializes a subdomain scanner service (block 520). The initialization can include loading the scanner's configuration settings (e.g., target root domain, scan depth, concurrency limits, and timeout settings). The initialization can also include allocation of computational resources and network bandwidth to ensure the subdomain scanner service can handle the workload efficiently without degrading performance. In addition, the initialization can include loading DNS resolution libraries, APIs, or databases that will be used to query DNS information. This might also involve setting up proxies or VPNs if anonymity is required or to circumvent rate-limiting issues.

The enumeration server system 118 can initialize the subdomain scanner service to operate simultaneously with the web crawler service and/or the SubscanLite service, before the web crawler service and/or the SubscanLite service, or after the web crawler service and/or the SubscanLite service. Moreover, one instance of the enumeration server system 118 may be configured to implement the web crawler service, a second instance of the enumeration server system 118 may be configured to implement the SubscanLite service, and a third instance of the enumeration server system 118 may be configured to implements the subdomain scanner service.

After initialization of the subdomain scanner service, the enumeration server system 118 performs the subdomain scan (block 522). In particular, the subdomain scan can include performing DNS queries for the root domain to identify DNS records that might point to subdomains (e.g., NS, A, AAAA, CNAME records). The subdomain scan can utilize direct queries, passive DNS sources, or both to gather initial data. The subdomain scan can use a list of common and subdomain names (dictionary) to generate potential subdomain names for the target domain. The subdomain scan can query DNS for these generated names to discover active subdomains.

In some implementations, the subdomain scan also includes brute force enumeration, during which a number of potential subdomain names are systematically generated and DNS queries are used to check for the existence of the generated subdomain names.

When a subdomain is found, the subdomain scan can perform additional scans on that subdomain to discover further nested subdomains, repeating the process to ensure comprehensive coverage. In some implementations, data from third-party sources, such as search engines, certificate transparency logs, and security databases, is used to find subdomains that might not be discovered through DNS queries alone.

After the enumeration server system 118 performs the subdomain scan, the enumeration server system 118 outputs the results of the subdomain scan (block 524). In particular, the enumeration server system 118 can aggregate the results from various methods and filter out duplicates to compile a clean list of discovered subdomains. The enumeration server system 118 can also validate the active status of these subdomains, ensuring the list is up-to-date and accurate. In some implementations, the enumeration server system 118 can perform an analysis of the discovered subdomains to categorize the discovered subdomains based on certain criteria (e.g., by function, security posture, or technology stack) and prioritize discovered subdomains for further investigation if necessary.

The enumeration server system 118 can generate a detailed report summarizing the discovered subdomains, including relevant DNS records, potential categorization, and any notable findings or anomalies detected during the scan. This report might also suggest next steps for security analysis or domain management.

After the web crawler service (blocks 502-508), the SubscanLite service (blocks 510-518), and the subdomain scanner service (blocks 520-524) are performed, the enumeration server system 118 determines whether a known domain exists (block 526). This determination can be performed for each domain—root and subdomain obtained via the aforementioned services. If a domain is determined to be known, the method 500 ends for that domain. Otherwise, if a domain is not known, then the enumeration server system 118 determines whether the domain is considered to be in-scope (block 528).

The enumeration server system 118 can determine whether a domain is “in-scope” by evaluating the domain against predefined criteria and objectives of a specific project, assessment, security policy, or other agreement. For instance, what is “in-scope” can be defined in an SLA, may be subject to a specific goal of the security service provider, whether the domain is part of a security assessment and/or a compliance audit, or any other project requiring domain evaluation. When the enumeration server system 118 determines that a domain is out-of-scope (i.e., not “in-scope) for a particular project, assessment, or security policy, the enumeration server system 118 drops the out-of-scope domain from further consideration. Otherwise, the enumeration server system 118 considers the domain to be in-scope and inserts the domain into a host table (e.g., maintained as part of the client data 110 (block 532). The host table serves as a centralized repository of domains and hosts that are relevant to the organization's IT environment, security posture, or specific project requirements. The host table can be structured to capture all necessary information about each domain. For instance, the host table can include fields for the domain name, IP addresses (if resolved), associated subdomains, the scope of inclusion (e.g., project name or assessment type), and any relevant notes such as the business function or criticality level.

After block 532, the method 500 proceeds to block 534 depicted in FIG. 5B. In FIG. 5B, the enumeration server system 118 determines whether the host domain added to the host table at block 532 is associated with a client asset 111 considered to be of high value (block 534). If so, the enumeration server system 118 can update a classification of the host domain to a “high value” classification (block 536). If not, the enumeration server system 118 can then determine whether the host domain is instead associated with a client asset 111 considered to be of moderate value (block 538). If so, the enumeration server system 118 can update a classification of the host domain to a “moderate value” classification (block 540). If the enumeration server system 118 determines that the host domain is not associated with a client asset 111 considered to be of high value (block 534) or of moderate value (block 538), the enumeration server system 118 updates the classification of the host domain to a “low value” classification (block 542).

The enumeration server system 118 can classify the client assets 111 into high, moderate, or low value in a host table, at least in part, by evaluating each asset based on several criteria that reflect its importance to the organization's operations, the sensitivity of the data the asset hosts, the asset's role in the IT infrastructure of the organization, and the potential impact the asset has on the organization's objectives and security posture. This classification guides prioritization for security measures, resource allocation, and risk management strategies.

By way of example, and not limitation, a high value asset can be an asset that is essential for the organization's core operations or directly impact revenue generation. This could include main websites, e-commerce platforms, or critical application servers. A high value asset can be configured to store or process sensitive data such as personal identifiable information, financial records, or proprietary business information that could cause significant harm if breached. A high value asset may be subject to stringent regulatory requirements where non-compliance could result in severe penalties, legal consequences, or reputational damage. Assets that, if compromised, could lead to severe operational disruption, financial loss, or endanger customer trust and safety can also be considered high value.

By way of further example, and not limitation, a moderate value asset can support important, but not critical, business functions. This could involve secondary websites, internal applications, or databases that facilitate day-to-day operations. Hosts that handle data which is sensitive but less impactful than that on high value assets. This might include internal communications or aggregated data with indirect identifiers. In addition, assets that are subject to regulatory oversight but with less stringent controls or penalties compared to those classified as high value may be classified as moderate value. Assets whose compromise would result in moderate operational difficulties or financial loss, impacting the organization but not threatening its viability can be considered of moderate value.

By way of another example, and not limitation, a low value asset may have minimal direct impact on business operations, such as test environments, marketing websites, or archival systems. Hosts primarily dealing with public information or data that, if exposed, would not significantly harm the organization or individuals can be classified as low value. Assets with little to no direct regulatory requirements or compliance considerations, posing minimal legal or compliance risk can also be classified as low value. Assets whose compromise would have minimal operational or financial impact, often due to their isolated nature or limited access to sensitive functions or data can be considered of low value.

From block 532 of FIG. 5A, the method 500 also proceeds to block 544. The enumeration server system 118 determines if a third-party provider hosts the subdomain (block 544). If a third-party provider hosts the subdomain, the enumeration server system 118 determines if the third-party provider is approved to be scanned (block 546). If the third-party provider is not approved to be scanned, the enumeration server system 118 determines that the domain is out-of-scope and is to be dropped. If the third-party provider is approved to be scanned, the method 500 proceeds to block 548. Also, if, at block 544, the enumeration server system 118 determines that the third-party provider does not host the subdomain, the method 500 proceeds to block 548.

The enumeration server system 118 determines if the host domain is associated with a web application (block 548). This determination can be performed simultaneously with the asset classification described above or separately before or after asset classification.

In one or more implementations, the enumeration server system 118 can determine if the host domain is associated with a web application by resolving the DNS records associated with the domain to identify any A, AAAA, or CNAME records that point to web servers. This can aid in confirming the presence of active hosting environments associated with the domain.

The enumeration server system 118 can also perform HTTP and HTTPS requests to the resolved addresses. A response from a web server, especially with a structured HTML or web application framework signature, strongly indicates the presence of a web application.

The enumeration server system 118 can analyze the content of any returned web pages for elements indicative of web applications, such as login forms, interactive features, API endpoints, or content management system (CMS) footprints.

The enumeration server system 118 can check the URL structure for paths that suggest application functionality, such as “/login,” “/admin,” or API versioning (“/api/v1”), which are common in web applications.

The enumeration server system 118 can deploy web crawling tools to systematically navigate and catalog the website structure hosted on the domain. These tools can identify application-like structures and interactive endpoints of web applications.

The enumeration server system 118 can utilize specialized tools designed to identify web applications and their technologies (e.g., Wappalyzer, BuiltWith). These tools can analyze a website to determine the web frameworks, programming languages, and server technologies in use.

The enumeration server system 118 can conduct a port scan targeting common web service ports (e.g., 80, 443, 8080). Open ports serving web content can further confirm the operation of web applications.

The enumeration server system 118 can perform subdomain enumeration for the domain to uncover additional hosts. Web applications are often hosted on subdomains (e.g., “app.example.com”), which might not be immediately apparent from the root domain.

The enumeration server system 118 can review SSL/TLS certificates for the domain and any subdomains. Certificates often cover multiple hostnames or subdomains and can provide clues about associated web applications or services.

The enumeration server system 118 can be configured to accept external input, such as from cybersecurity experts or web developers who manually review the findings and the website content. This can help in verifying the automated tools' conclusions and uncovering nuanced application functionalities that might not be easily detected. Machine learning technologies can also be implemented to ascertain whether a domain is associated with a web application.

The determination of whether or not a domain is associated with a web application (block 548) can be based on information obtained via the web crawler service, the SubscanLite service, and the subdomain scanner service described above with reference to FIG. 5A.

When the enumeration server system 118 identifies a domain as hosting a web application, the enumeration server system 118 adds a new host to a port scan (block 550) and to a DAST scan (block 552). Otherwise, the enumeration server system 118 add a new host only to the port scan (block 554).

### Reputational Review

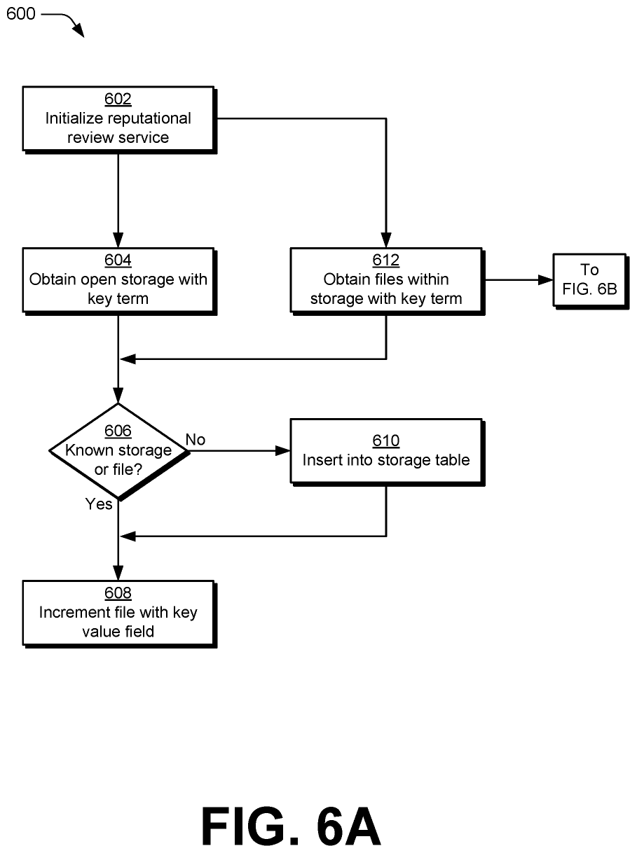

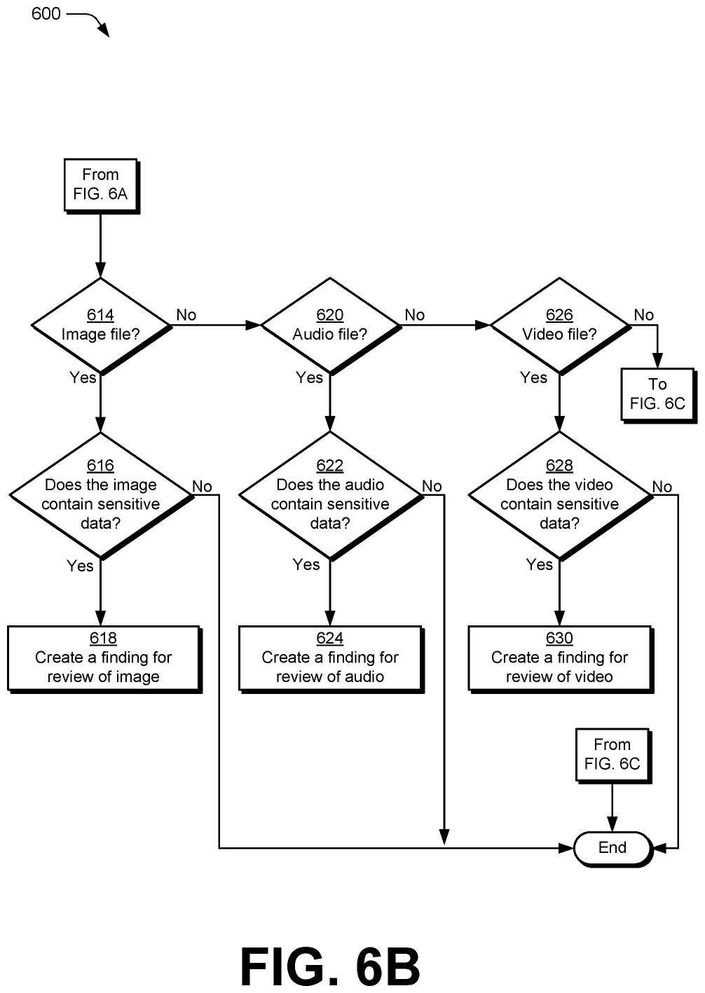

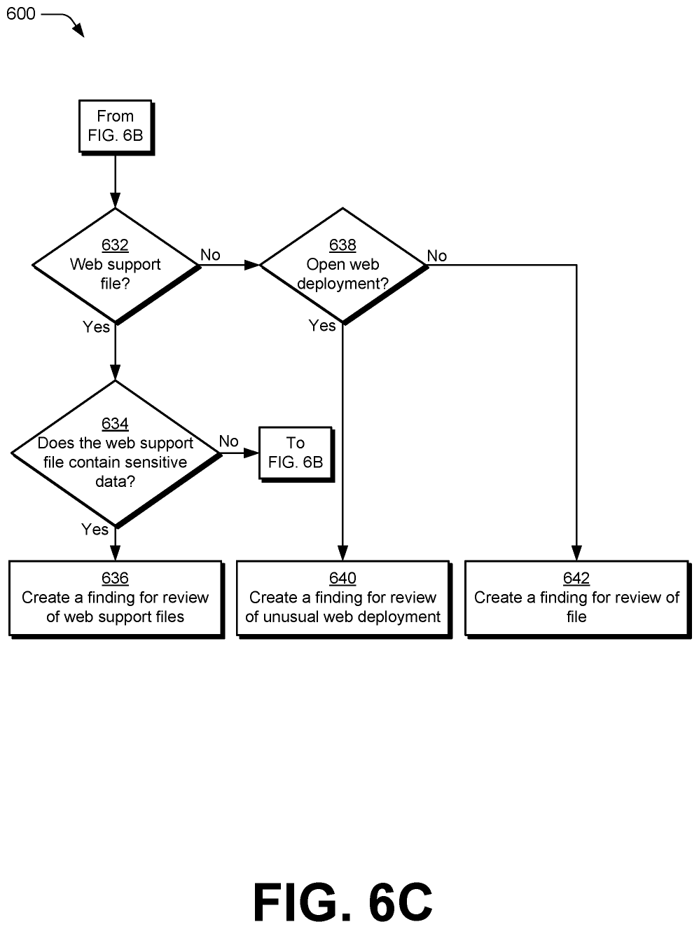

FIGS. 6A-6C depicts a flow diagram of a method 600 for reputational review according to an example implementation. The method 600 will be described as being performed by the scanner cluster server system 116, particularly via execution of the reputational review module 212.

The scanner cluster server system 116 initializes a reputational review service (block 602). Specifically, the scanner cluster server system 116 can load a service's configuration, initialize a database connection (e.g., to the database server system 108 and the caching server system 112), and prepare any resources and/or APIs to be utilized as part of the review process.

The scanner cluster server system 116 then uses the reputational review service to query an external data source or an internal database for storage or files that matches a specific key term (block 604 and block 612). This storage or file represent a collection of data, a digital asset, or any other entity relevant to the reputational review.

The scanner cluster server system 116 then determines if the storage or file is known (block 606). For instance, the scanner cluster server system 116 can query the service's database to determine if the storage or file with the specified key term already exists within a record. In addition, or alternatively, the scanner cluster server system 116 can use the key term as a query parameter to search the relevant table(s) or collection(s) in the database.

If the storage or file is determined by the scanner cluster server system 116 to be a known storage or file, the scanner cluster server system 116 identifies the record associated with the known storage or file in the database and updates the record by incrementing a key value field (block 608). The key value field can track metrics such as the number of times the storage or file has been reviewed, its reputational score, or other relevant metrics.

Alternatively, if the storage or file is not known, the scanner cluster server system 116 can create a new database record for the storage or file, including the key term and any initial data or metrics relevant to the reputational review, set initial values for any reputational metrics or status indicators for the new storage or file (if applicable), and add the new record into the storage or file table in the database (block 610). The method 600 then continues as described above for block 608.

When files are identified, the scanner cluster server system 116 determines if the file is an image file (block 614). If the file is an image, then the scanner cluster server system 116 identifies if there are indications of sensitive data (block 616) and, if so, a finding for further review is created (block 618).

If the scanner cluster server system 116 determines that the file is an audio file (block 620) and the audio file contains sensitive data (block 622), then a finding is created for further review (block 624). Alternatively, if the file is indicated to be a video file (block 626) and the video file contains sensitive data (block 628), then a finding is created for further review (block 630).

If the files are identified to be web support files (block 632 in FIG. 6C) and contain sensitive data (block 634), then a finding for further review will be created (block 636). Alternatively, if the files indicate an unusual web deployment (block 638) a finding will be created for further review (block 640), else a finding will be created to review the file (block 642).

### Populating ToScan Table

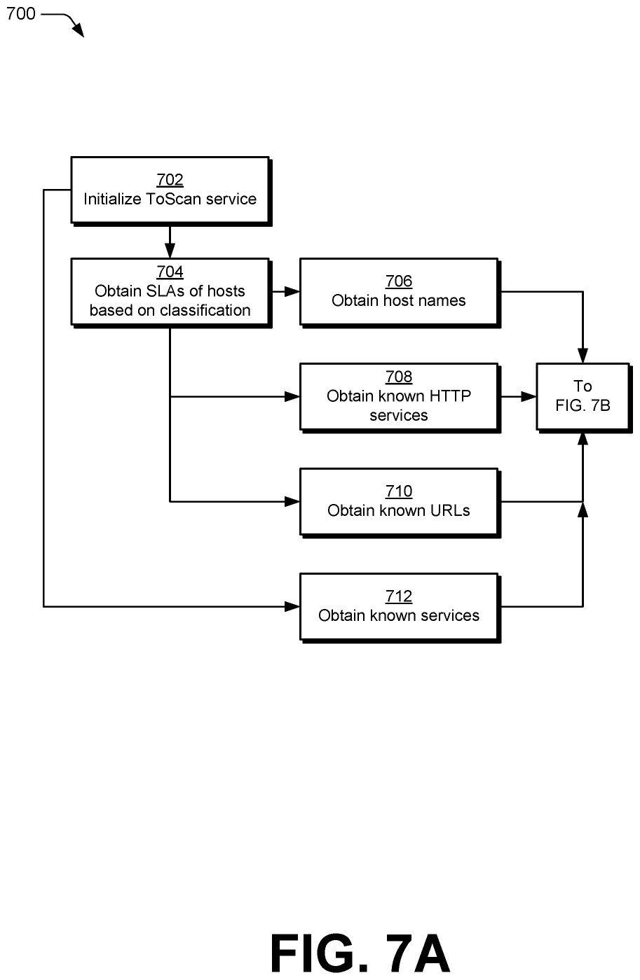

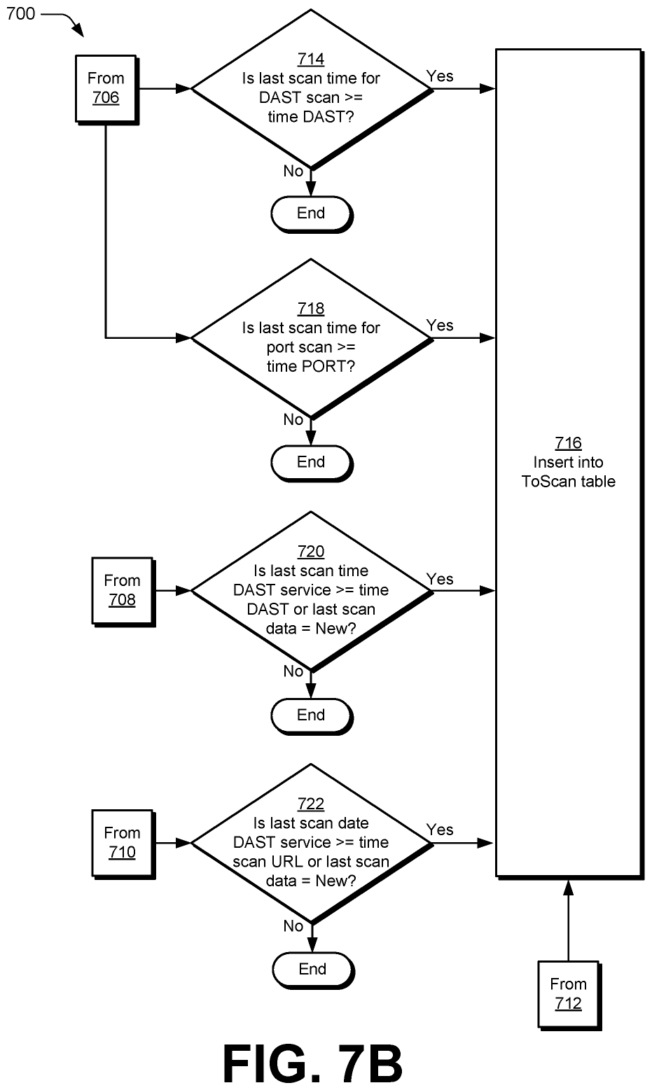

FIGS. 7A-7B depict a flow diagram of a method 700 for populating a ToScan table for port and DAST rescanning according to an example implementation. The method 700 will be described as being performed by the scanner cluster server system 116 via execution of the DAST scanning module 202.

The method 700 begins and the scanner cluster server system 116 initializes a ToScan service (block 702). The scanner cluster server system 116 first obtains SLAs of hosts based on classification. For each classified host, the scanner cluster server system 116 retrieves SLA details, such as part of the client data 110. These details may include uptime requirements, maintenance windows, security compliance levels, and performance benchmarks. The scanner cluster server system 116 then obtains host names (block 706), known HTTP services (block 708), and known URLs (block 710). The scanner cluster server system 116 also obtains known services (block 712) after service initialization. The method 700 then proceeds to FIG. 7B.

After obtaining host names (block 706), the scanner cluster server system 116 determines if the last scan time for a DAST scan is greater than or equal to a specified time threshold (“time DAST”). This process ensures that web applications and services are regularly assessed for vulnerabilities. In some implementations, the scanner cluster server system 116 can access DAST scan results stored, for example, in the database server system 108, the caching server system 112, or the storage instances 124. The DAST scan results can include timestamps of each scan, the host names or URLs scanned, and the findings of those scans. The scanner cluster server system 116 can determine the timestamp of the most recent DAST scan. This involves sorting or querying the scan records based on the scan date or timestamp, ensuring that the latest scan for each host is identified. The scanner cluster server system 116 may also normalize timestamps to a standard format or time zone to accurately compare scan times across different systems or regions. The scanner cluster server system 116 also establishes a threshold time DAST, which represents the maximum acceptable interval between DAST scans. This threshold is typically defined based on security policies, compliance requirements, or risk management strategies. The scanner cluster server system 116 also compares the timestamp of the last DAST scan to the time DAST threshold to determine if the last scan was conducted within an acceptable timeframe.

If the last scan time for the DAST scan is less than time DAST, then the host does not need to be rescanned and the method 700 ends. If, however, the last scan time for the DAST scan is greater than or equal to time DAST, then the host is added to a ToScan table to be rescanned (block 716).

After obtaining host names (block 706), the scanner cluster server system 116 determines if the last scan time for a port scan is greater than or equal to a specified time threshold (“time PORT”) (block 718). This process ensures that web applications and services are regularly assessed for vulnerabilities. In some implementations, the scanner cluster server system 116 can access port scan results stored, for example, in the database server system 108, the caching server system 112, or the storage instances 124. The port scan results can include timestamps of each scan, the host names or URLs scanned, and the findings of those scans. The scanner cluster server system 116 can determine the timestamp of the most recent port scan. This involves sorting or querying the scan records based on the scan date or timestamp, ensuring that the latest scan for each host is identified. The scanner cluster server system 116 may also normalize timestamps to a standard format or time zone to accurately compare scan times across different systems or regions. The scanner cluster server system 116 also establishes a threshold time PORT, which represents the maximum acceptable interval between PORT scans. This threshold is typically defined based on security policies, compliance requirements, or risk management strategies. The scanner cluster server system 116 also compares the timestamp of the last PORT scan to the time PORT threshold to determine if the last scan was conducted within an acceptable timeframe.

If the last scan time for the PORT scan is less than time PORT, then the host does not need to be rescanned and the method 700 ends. If, however, the last scan time for the PORT scan is greater than or equal to time PORT, then the host is added to a ToScan table to be rescanned (block 716).

After obtaining a list of known HTTP services (block 708), the scanner cluster server system 116 determines whether the last scan time for a DAST scan is greater than or equal to a specified time threshold (“time DAST”) or if the HTTP service has never been scanned before (i.e., last scan data is equal to “new”) (block 720). If the last scan time for a DAST scan is less than time DAST, then the HTTP service does not need to be rescanned and the method 700 ends. If, however, the last scan time for the DAST scan is greater than or equal to time DAST or the last scan data is equal to “new,” then the HTTP service is added to the ToScan table to be rescanned (block 716).

After obtaining a list of known URLs (block 710), the scanner cluster server system 116 determines whether the last scan time for a DAST scan is greater than or equal to a specified time threshold (“time DAST”) or if the URL has never been scanned before (i.e., last scan data is equal to “new”) (block 722). If the last scan time for a DAST scan is less than time DAST, then the URL does not need to be rescanned and the method 700 ends. If, however, the last scan time for the DAST scan is greater than or equal to time DAST or the last scan data is equal to “new,” then the URL is added to the ToScan table to be rescanned (block 716).

After obtaining a list of known services (block 712), the scanner cluster server system 116 adds the known services to the ToScan table to be rescanned (block 716).

### DAST Scan Service Process

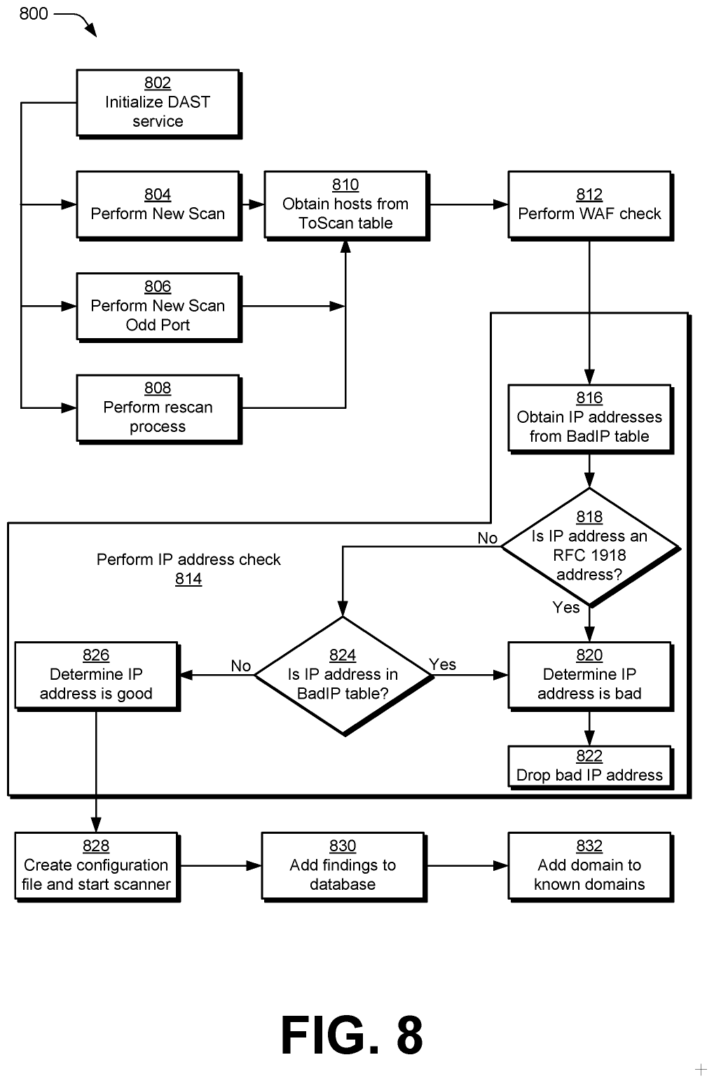

FIG. 8 depicts a flow diagram of a method 800 for implementing a DAST scan service according to an example implementation. The method 800 will be described as being performed by the scanner cluster server system 116 via execution of the DAST scanning module 202.

The scanner cluster server system 116 initializes a DAST scan service (block 802. In some implementations, the scanner cluster server system 116 boots up the service software (e.g., the DAST scanning module 202), loads configuration files, and ensures all necessary dependencies are operational. The scanner cluster server system 116 can then perform a new scan (block 804), a new scan for an odd port (block 806), or a rescan (block 808). The scanner cluster server system 116 then obtains hosts from the ToScan table (block 810). The scanner cluster server system 116 then performs a web application firewall (WAF) check using the hosts from the ToScan table to identify which hosts are running web applications or services that would be protected by a WAF (block 812).

The scanner cluster server system 116 then performs an IP address check (block 814) to determine its categorization, especially when considering whether an IP address is private (e.g., as defined by RFC 1918) or has been flagged for being associated with malicious activity (indicated in a “badIP” table). In particular, to perform the IP address check, the scanner cluster server system 116 can obtain IP address from a BadIP table (block 816) and, for each IP address in the BadIP table, determine if the IP address is an RFC 1918 address (e.g., a private IP address within a range defined in RFC 1918) (block 818). If the IP address is an RFC 1918 address, then the scanner cluster server system 116 can determine that the IP address is “bad” in the context of being inappropriately exposed or used in communications where a public IP should be present (block 820). The scanner cluster server system 116 then implements measures to block or drop traffic to and from this IP address (block 822).

If the scanner cluster server system 116 determines that the IP address is not a private RFC 1918 address, the scanner cluster server system 116 queries the BadIP table, which contains IP addresses known or suspected to be associated with malicious activities. If the IP address is found in the BadIP table, the scanner cluster server system 116 concludes that the IP address is bad (block 820) and proceeds to drop the bad IP address (block 822) as described above. If instead the scanner cluster server system 116 determines the IP address is neither a private RFC 1918 IP address (block 818) nor found in the BadIP table (block 820), the scanner cluster server system 116 determines the IP address is good (block 826).

After completing the IP address categorization process and determining whether an IP address is “bad” or “good,” the scanner cluster server system 116 creates configuration file for a scanner and starts the scanner (block 828), adds findings to a database (e.g., the database server system 108 or the caching server system 112) (block 830), and adds the domain associated with the IP address to the list of known domains (block 832).

### Dashboard User Interfaces

FIGS. 9 and 10 depict user interface diagrams showing various aspects of user interfaces implemented as dashboards 900, 1000 for presenting security vulnerability findings, visualizations, and other associated data according to example implementations. The dashboards 900, 1000 are representative of user interfaces that can be presented to clients via the client interaction system(s) 130. The dashboards 900, 1000, more particularly, are illustrative of the client dashboard 132. It should be understood, however, that aspects of the dashboards 900, 1000 can be implemented as part of the client portal 134 and/or the client application 136.

The layouts of the dashboards 900, 1000 are merely illustrative and not intended to impart any limitations on the design (i.e., look and feel) or useability of the dashboards 900, 1000. Moreover, the dashboards 900, 1000 are capable of being presented via various client interaction systems 130 that facilitate user interaction through various modes and devices, some examples of which include, but are not limited to, pointing devices, touchscreens, keyboard input, voice commands, gesture recognition, eye tracking, brain-computer interfaces, haptic feedback, game controllers, joysticks, remote controls, or some combination thereof.

Turning first to FIG. 9, the dashboard 900 enables users (e.g., client users, security provider users, etc.) to monitor and manage security findings, host information, and certificate statuses. Specifically, the dashboard 900 includes a pending retest findings 902 section that provides a number of critical findings with retests pending (904), a number of high findings with retests pending (906), and a number of moderate findings with retests pending (908). The dashboard 900 also includes a pending fix findings 910 section that provides a number of critical findings pending fix (912), a number of high findings pending fix (914), and a number of moderate findings pending fix (916). A certificate expiration 918 section is also shown having a number of certificates expiring within thirty days or less (920), a number of certificates expiring thirty-one to sixty days (922), and a number of certificates expiring sixty-one days or more (924). The dashboard 900 also includes an accepted findings 926 section that provides a number of accepted critical findings 928, a number of accepted high findings 930, and a number of accepted moderate findings 932. A newly discover hosts 934 section is also shown. This section identifies newly discovered hosts via hostnames 936, IP addresses 938, open ports 940, and date/time of first scan 942. Lastly, the dashboard 900 includes one or more visualizations 944(0)-944(N).

The pending retest findings 902 section, the pending fix findings 910 section, the certificate expiration 918 section, and the accepted findings 926 section can be color-coded according to severity level and/or the count of findings to easily distinguish among the numbers presented via the dashboard 900 and allow the user to quickly assess the status of their assets. For example, the “critical” numbers may be presented in red, the “high” numbers may be presented in pink or another “hot” color to indicate less severity than the “critical” numbers, and the “moderate” numbers may be presented in orange. Numbers that are currently zero can be reflected in green or another color representative of everything being “OK.” Similar colors can be used for the certificate expiration 918 section. These colors can be changed based on a user preferences, a client preferences, security service provider preferences, to accommodate color blindness, or for any other reason. Grayscale, patterns, gradients, shapes, and/or other visual effects can be used to distinguish among severities. For implementations that incorporate haptic feedback, the severity can be distinguished, for example, by changes in vibration intensity commensurate with severity.

The visualizations 944 can be or can include graphical representations such as pie charts, bar graphs, and line charts visualize the data distribution across different metrics (e.g., findings severity, certificate expiration timelines, and so on). The visualizations 944 are designed to offer quick insights into trends, patterns, and areas requiring attention.

FIG. 10 depicts the dashboard 1000 that enables (e.g., client users, security provider users, etc.) to review key data points from security procedures, focusing on open external services, findings management, IP location tracking, and active findings details. Specifically, the dashboard 1000 includes an open external services 1002 section that uses icons and labels to represent different types and numbers of open external services, including an FPT service 1004, an HTTP service 1006, and HTTPS service 1008, database service 1010, RDP service 1012, and SSH service 1014. Each service type can have a dedicated widget or card, with a service-specific icon for immediate recognition. Alternatively, simple labels can be used alone or in addition to visualizations representative of the number of each open external service. For example, a numeric indicator can show the current count of open services detected for that type. The background or color of the widget can change based on the risk level associated with the open services count (e.g., red for high risk, pink/yellow for moderate risk, or green for low risk) Users can click or otherwise interact with a service widget to drill down into a list or report detailing the specific open services, including hostnames, IP addresses, and recommended actions.

The dashboard 1000 also includes a findings count total 1016 section that includes a visualization, a widget, or a series of widgets or summary cards that display the total counts for different findings categories, such as pending fix count 1018, fixed count 1020, accepted count 1022, and retest requested count 1024. Each category can be visually distinct, using color coding and/or icons. Clicking or otherwise interacting with a widget can expand that widget into a detailed view, listing the findings within that category. The detailed view can include information such as the findings title, associated asset, severity, and date identified.

The dashboard 1000 also includes an IP location map 1026 section that presents and interactive map (e.g., world, country, region, state, and so on) highlighting the geographical locations from which IP addresses associated with the open external services originate. Locations with active IP addresses can be marked with pins, heat spots, or other visual indicators (1028). The IP location map 1026 can integrate real-time data, showing the concentration of IP addresses by region. Hovering over, clicking, or otherwise interacting with a location can reveal a summary of the IP addresses detected, the types of services found, and any associated findings.

The dashboard 1000 also includes an active findings 1030 section in which active findings are presented, for example, in a tabulated list format, including columns for findings title 1032, asset 1034 (e.g., by hostname or IP address), findings URL 1036 (if applicable), and status 1038 (e.g., accepted, pending fix). Users can sort the list by any column header and apply filters to narrow down the findings displayed based on criteria such as severity, date range, or status.

FIG. 11 is a block diagram illustrating a computer system 1100 configured to provide the functionality in accordance with various embodiments of the concepts and technologies disclosed herein is illustrated. The systems, devices, and other components disclosed herein can utilize, at least in part, an architecture that is the same as or at least similar to the architecture of the computer system 1100, for example, the database server system 108, the caching server system 112, the scanner cluster server system 116, the enumeration server system 118, the environment utility server system 120, the IAM server system 122, the secret management server system 128, the client interaction systems 130, and the environment monitoring system 148. It should be understood, however, that modification to the architecture may be made to facilitate certain interactions among elements described herein.

The computer system 1100 includes a processing unit 1102, a memory 1104, one or more user interface devices 1106, one or more input/output (“I/O”) devices 1108, and one or more network devices 1110, each of which is operatively connected to a system bus 1112. The system bus 1112 enables bi-directional communication between the processing unit 1102, the memory 1104, the user interface devices 1106, the I/O devices 1108, and the network devices 1110.

The processing unit 1102 may be a standard central processor that performs arithmetic and logical operations, a more specific purpose programmable logic controller (“PLC”), a programmable gate array, or other type of processor known to those skilled in the art and suitable for controlling the operation of the computer system 1100. Processing units are known, and therefore are not described in further detail herein.

The memory 1104 communicates with the processing unit 1102 via the system bus 1112. In some embodiments, the memory 1104 is operatively connected to a memory controller (not shown) that enables communication with the processing unit 1102 via the system bus 1112. The illustrated memory 1104 includes an operating system 1114 and one or more program modules 1116. The operating system 1114 can include, but is not limited to, members of the WINDOWS family of operating systems from MICROSOFT CORPORATION, the LINUX family of operating systems, the MAC OS family of operating systems from APPLE CORPORATION, the FREEBSD family of operating systems, the SOLARIS family of operating systems from ORACLE CORPORATION, other operating systems, and the like.

The program modules 1116 may include various software and/or program modules to perform the various operations described herein. The program modules 1116 and/or other programs can be embodied in computer-readable media containing instructions that, when executed by the processing unit 1102, perform various operations such as those described herein. According to embodiments, the program modules 1116 may be embodied in hardware, software, firmware, or any combination thereof.

By way of example, and not limitation, computer-readable media may include any available computer storage media or communication media that can be accessed by the computer system 1100. Communication media includes computer-readable instructions, data structures, program modules, or other data in a modulated data signal such as a carrier wave or other transport mechanism and includes any delivery media. The term “modulated data signal” means a signal that has one or more of its characteristics changed or set in a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

Computer storage media includes volatile and non-volatile, removable and non-removable media implemented in any method or technology for storage of information such as computer-readable instructions, data structures, program modules, or other data. Computer storage media includes, but is not limited to, random access memory (RAM), read-only memory (ROM), erasable programmable ROM (“EPROM”), electrically erasable programmable ROM (“EEPROM”), flash memory or other solid state memory technology, CD-ROM, digital versatile disks (“DVD”), or other optical storage, magnetic cassettes, magnetic tape, magnetic disk storage or other magnetic storage devices, or any other medium which can be used to store the desired information and which can be accessed by the computer system 1100. In the claims, the phrase “computer-readable storage medium” and variations thereof does not include waves or signals per se and/or communication media.

The user interface devices 1106 may include one or more devices with which a user accesses the computer system 1100. The user interface devices 1106 may include, but are not limited to, computers, servers, PDAs, cellular phones, or any suitable computing devices. The I/O devices 1108 enable a user to interface with the program modules 1116. In one embodiment, the I/O devices 1108 are operatively connected to an I/O controller (not shown) that enables communication with the processing unit 1102 via the system bus 1111. The I/O devices 1108 may include one or more input devices, such as, but not limited to, a keyboard, a mouse, or an electronic stylus. Further, the I/O devices 1108 may include one or more output devices, such as, but not limited to, a display screen or a printer. In some embodiments, the I/O devices 1108 can be used for manual controls for operations to exercise under certain emergency situations.

The network devices 1110 enable the computer system 1100 to communicate with other networks or remote systems via a network 1118. Examples of the network devices 1110 include, but are not limited to, a modem, a radio frequency (“RF”) or infrared (“IR”) transceiver, a telephonic interface, a bridge, a router, a switch, a network card.

The concepts and technologies described herein are supported by various configurations of the computer system 1100 and are not limited to the specific examples of the concepts and technologies described herein. This functionality is also implementable all or in part through use of a distributed system, such as over a network 1118 via a cloud platform 1120 as described below.

The network 1118 includes and/or is representative of a cloud platform 1120 for resources 1122. The cloud platform 1120 abstracts underlying functionality of hardware (e.g., servers) and software resources of the network 1118. The resources 1122 include applications and/or data that can be utilized while computer processing is executed on servers that are remote from the computing system 1100. Resources 1122 can also include services provided over the Internet and/or through a subscriber network, such as a cellular or Wi-Fi network.

The cloud platform 1120 abstracts resources and functions to connect the computer system 1100 with other computing devices. The cloud platform 1120 also serves to abstract scaling of resources to provide a corresponding level of scale to encountered demand for the resources 1122 that are implemented via the cloud platform 1120. Accordingly, in an interconnected device embodiment, implementation of functionality described herein is distributable throughout the computer system 1100. For example, the functionality is implementable in part on the computer system 1100 as well as via the cloud platform 1120 that abstracts the functionality of the network 1118.

In implementations, the cloud platform 1120 employs a “machine-learning model” that is configured to implement the concepts and technologies described herein. A machine-learning model refers to a computer representation that can be tuned (e.g., trained and retrained) based on inputs to approximate unknown functions. In particular, the term machine-learning model can include a model that utilizes algorithms to learn from, and make predictions on, known data by analyzing training data to learn and relearn to generate outputs that reflect patterns and attributes of the training data. Examples of machine-learning models include neural networks, convolutional neural networks (CNNs), long short-term memory (LSTM) neural networks, decision trees, and so forth.

Turning now to FIG. 12, an example cloud platform 1200 will be described, according to an exemplary embodiment. The architecture of the cloud platform 1200 can be used to implement, at least in part, the distributed computing environment 102 disclosed herein. For example, the cloud platform 1200 can be utilized to implement at least a portion of the relational database instances 106, the virtual compute instances 114, and/or the one or more storage instances 124. In addition, the cloud platform 1200 can be used to implement the environment utility server system 120, the IAM server system 122, the secret management server system 128, or portions thereof.

The cloud platform 1200 is a shared infrastructure that can support multiple services and network applications. The illustrated cloud platform 1200 includes a hardware resource layer 1202, a virtualization/control layer 1204, and a virtual resource layer 1206 that work together to perform operations as will be described in detail herein.

The hardware resource layer 1202 provides hardware resources, which, in the illustrated embodiment, include one or more compute resources 1208, one or more memory resources 1210, and one or more other resources 1212. The compute resource(s) 1208 can include one or more hardware components that perform computations to process data, and/or to execute computer-executable instructions of one or more application programs, operating systems, and/or other software. The compute resources 1208 can include one or more central processing units (“CPUs”) configured with one or more processing cores. The compute resources 1208 can include one or more graphics processing unit (“GPU”) configured to accelerate operations performed by one or more CPUs, and/or to perform computations to process data, and/or to execute computer-executable instructions of one or more application programs, operating systems, and/or other software that may or may not include instructions particular to graphics computations. In some implementations, the compute resources 1208 can include one or more discrete GPUs. In some other implementations, the compute resources 1208 can include CPU and GPU components that are configured in accordance with a co-processing CPU/GPU computing model, wherein the sequential part of an application executes on the CPU and the computationally intensive part is accelerated by the GPU.

The compute resources 1208 can include one or more system-on-chip (“SoC”) components along with one or more other components, including, for example, one or more of the memory resources 1210, and/or one or more of the other resources 1212. In some embodiments, the compute resources 1208 can be or can include one or more SNAPDRAGON SoCs, available from QUALCOMM of San Diego, Calif.; one or more TEGRA SoCs, available from NVIDIA of Santa Clara, Calif.; one or more HUMMINGBIRD SoCs, available from SAMSUNG of Seoul, South Korea; one or more Open Multimedia Application Platform (“OMAP”) SoCs, available from TEXAS INSTRUMENTS of Dallas, Tex.; one or more customized versions of any of the above SoCs; and/or one or more proprietary SoCs. The compute resources 1208 can be or can include one or more hardware components architected in accordance with an ARM architecture, available for license from ARM HOLDINGS of Cambridge, United Kingdom. Alternatively, the compute resources 1208 can be or can include one or more hardware components architected in accordance with an x86 architecture, such an architecture available from INTEL CORPORATION of Mountain View, Calif., and others. Those skilled in the art will appreciate the implementation of the compute resources 1208 can utilize various computation architectures, and as such, the compute resources 1208 should not be construed as being limited to any particular computation architecture or combination of computation architectures, including those explicitly disclosed herein.

The memory resource(s) 1210 can include one or more hardware components that perform storage operations, including temporary or permanent storage operations. In some embodiments, the memory resource(s) 1210 include volatile and/or non-volatile memory implemented in any method or technology for storage of information such as computer-readable instructions, data structures, program modules, or other data disclosed herein. Computer storage media includes, but is not limited to, RAM, ROM, EPROM, EEPROM, flash memory or other solid state memory technology, CD-ROM, DVD, or other optical storage, magnetic cassettes, magnetic tape, magnetic disk storage or other magnetic storage devices, or any other medium which can be used to store data and which can be accessed by the compute resources 1208.

The other resource(s) 1212 can include any other hardware resources that can be utilized by the compute resources(s) 1208 and/or the memory resource(s) 1210 to perform operations described herein. The other resource(s) 1212 can include one or more input and/or output processors (e.g., network interface controller or wireless radio), one or more modems, one or more codec chipset, one or more pipeline processors, one or more fast Fourier transform (FFT) processors, one or more digital signal processors (DSPs), one or more speech synthesizers, and/or the like.

The hardware resources operating within the hardware resources layer 1202 can be virtualized by one or more virtual machine monitors (VMMs) 1214 (also known as “hypervisors”) operating within the virtualization/control layer 1204 to manage one or more virtual resources that reside in the virtual resource layer 1206. The VMMs 1214 can be or can include software, firmware, and/or hardware that alone or in combination with other software, firmware, and/or hardware, manages one or more virtual resources operating within the virtual resource layer 1206.

The virtual resources operating within the virtual resource layer 1206 can include abstractions of at least a portion of the compute resources 1208, the memory resources 1210, the other resources 1212, or any combination thereof. These abstractions are referred to herein as virtual machines (VMs). In the illustrated implementation, the virtual resource layer 1206 includes VMs 1216. Each of the VMs 1216 can execute one or more applications.

It should be understood that many variations are possible based on the disclosure herein. Although features and elements are described above in particular combinations, each feature or element is usable alone without the other features and elements or in various combinations with or without other features and elements.

The various functional units illustrated in the figures and/or described herein (including, where appropriate, the distributed computing environment 102, the VPC 104, the relational database instances 10, the database server system 108, the client assets 111, the caching server system 112, the virtual compute instances 114, the scanner cluster server system 116, the enumeration server system 118, the environment utility server system 120, the IAM server system 122, the one or more storage instances 124, the secret management server system 128, the client interaction systems 130, the source code repositories 142, and/or the distributed computing environment monitoring system 148) are implemented in any of a variety of different manners such as hardware circuitry, software or firmware executing on a programmable processor, or any combination of two or more of hardware, software, and firmware. The method provided is implemented in any of a variety of devices, such as a general-purpose computer, a processor, or a processor core. Suitable processors include, by way of example, a general purpose processor, a special purpose processor, a conventional processor, a digital signal processor (DSP), a graphics processing unit (GPU), a parallel accelerated processor, a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a quantum computer, a hybrid quantum/classical computer, and/or a state machine.

In one or more implementations, the methods and procedures provided herein are implemented in a computer program, software, or firmware incorporated in a non-transitory computer-readable storage medium for execution by a general-purpose computer or a processor. Examples of non-transitory computer-readable storage mediums include a read only memory (ROM), a random-access memory (RAM), a register, cache memory, semiconductor memory devices, magnetic media such as internal hard disks and removable disks, magneto-optical media, and optical media such as CD-ROM disks, and digital versatile disks (DVDs).

What is claimed is:

1. A method comprising:
executing, by an enumeration server system, a web crawl using a plurality of seed uniform resource locators;
executing, by the enumeration server system, a domain name service subdomain scan;
executing, by the enumeration server system, a subdomain scan;
obtaining, by the enumeration server system, asset data associated with one or more client assets; and
determining, by the enumeration server system, based upon the asset data and results of the web crawl, the domain name service subdomain scan, and the subdomain scan, whether each domain of a plurality of domains is known.

2. The method of claim 1, wherein executing, by the enumeration server system, the web crawl comprises:
initializing, by the enumeration server system, a web crawler service;
obtaining, by the enumeration server system, the plurality of seed uniform resource locators as initial points of entry for the web crawl;
performing, by the enumeration server system, the web crawl via the web crawler service using the plurality of seed uniform resource locators as the initial points of entry for the web crawl; and
outputting, by the enumeration server system, results of the web crawl.

3. The method of claim 1, further comprising:
responsive to determining a specific domain of the plurality of domains is unknown, determining, by the enumeration server system, whether the specific domain of the plurality of domains is in-scope.

4. The method of claim 3, further comprising:
responsive to determining that the specific domain of the plurality of domains is out-of-scope, dropping, by the enumeration server system, the specific domain from further consideration.

5. The method of claim 3, further comprising:
responsive to determining that the specific domain of the plurality of domains is in-scope, inserting, by the enumeration server system, the specific domain into a host table for further consideration.

6. The method of claim 5, further comprising:
classifying, by the enumeration server system, the specific domain based on an assessed significance of the one or more client assets.

7. The method of claim 5, further comprising:
determining, by the enumeration server system, whether the specific domain is hosted by a third-party.

8. The method of claim 7, further comprising:
responsive to determining that the specific domain is hosted by the third-party, determining, by the enumeration server system, whether the specific domain is approved to be scanned; and
responsive to determining that the specific domain is hosted by the third-party and is approved to be scanned, determining, by the enumeration server system, whether the specific domain is associated with a web application.

9. The method of claim 8, further comprising:
responsive to determining that the specific domain is associated with the web application, adding, by the enumeration server system, a new host associated with the specific domain to a port scan and to a dynamic application security testing scan; and
instructing, by the enumeration server system, a scanner cluster server system to perform the port scan and the dynamic application security testing scan on the new host.

10. The method of claim 8, further comprising:
responsive to determining that the specific domain is associated with the web application, adding, by the enumeration server system, a new host associated with the specific domain to a port scan; and
instructing, by the enumeration server system, a scanner cluster server system to perform the port scan on the new host.

11. A system comprising:
a processor; and
a memory comprising computer-executable instructions that, when executed by the processor, cause the processor to perform operations comprising:
executing a web crawl using a plurality of seed uniform resource locators;
executing a domain name service subdomain scan;
executing a subdomain scan;
obtaining asset data associated with one or more client assets; and
determining, based upon the asset data and results of the web crawl, the domain name service subdomain scan, and the subdomain scan, whether each domain of a plurality of domains is known.

12. The system of claim 11, wherein executing the web crawl comprises:
initializing a web crawler service;
obtaining the plurality of seed uniform resource locators as initial points of entry for the web crawl;
performing the web crawl via the web crawler service using the plurality of seed uniform resource locators as the initial points of entry for the web crawl; and
outputting results of the web crawl.

13. The system of claim 11, wherein the operations further comprise:
responsive to determining a specific domain of the plurality of domains is unknown, determining whether the specific domain of the plurality of domains is in-scope.

14. The system of claim 13, wherein the operations further comprise:
responsive to determining that the specific domain of the plurality of domains is out-of-scope, dropping the specific domain from further consideration; or
responsive to determining that the specific domain of the plurality of domains is in-scope, inserting the specific domain into a host table for further consideration.

15. The system of claim 14, wherein the operations further comprise:
classifying the specific domain based on an assessed significance of the one or more client assets.

16. The system of claim 14, wherein the operations further comprise:
determining whether the specific domain is hosted by a third-party.

17. The system of claim 16, wherein the operations further comprise:
responsive to determining that the specific domain is hosted by the third-party, determining whether the specific domain is approved to be scanned; and
responsive to determining that the specific domain is hosted by the third-party and is approved to be scanned, determining whether the specific domain is associated with a web application.

18. The system of claim 17, wherein the operations further comprise:
responsive to determining that the specific domain is associated with the web application, adding a new host associated with the specific domain to a port scan and to a dynamic application security testing scan; and
instructing a scanner cluster server system to perform the port scan and the dynamic application security testing scan on the new host.

19. The system of claim 17, wherein the operations further comprise:
responsive to determining that the specific domain is associated with the web application, adding a new host associated with the specific domain to a port scan; and
instructing a scanner cluster server system to perform the port scan on the new host.

20. A computer-readable storage medium having computer-executable instructions stored thereon that, when executed by a processor, cause the processor to perform operations comprising:
obtaining asset data associated with one or more client assets;
determining, based upon the asset data, results of a web crawl, results of a domain name service subdomain scan, and results of a subdomain scan, whether each domain of a plurality of domains is known;
responsive to determining a specific domain of the plurality of domains is unknown, determining whether the specific domain of the plurality of domains is in-scope;
responsive to determining that the specific domain of the plurality of domains is in-scope, inserting the specific domain into a host table for further consideration; and
classifying the specific domain based on an assessed significance of the one or more client assets.
